(19) United States
(12) Patent Application Publication
(10) Pub. No.: US 2025/0271931 A1
(43) Pub. Date: Aug. 28, 2025

(54) HAPTIC GLOVE SYSTEM AND MANUFACTURE OF HAPTIC GLOVE SYSTEMS

(71) Applicant: Hatpx, Inc., San Luis Obispo, CA (US)

(72) Inventors: Jacob A. Rubin, Morro Bay, CA (US); Robert S. Crockett, San Luis Obispo, CA (US); Michael C. Eichermueller, Arroyo Grande, CA (US); Benjamin John Medeiros, Coeur d'Alene, ID (US); Jason Patrick Covey, Rusk, TX (US); Bret Thomas Stewart, Rathdrum, ID (US); Joanna Jin Liu, San Luis Obispo, CA (US); Donald Jeong Lee, San Luis Obispo, CA (US); Bodin Limsowan Rojanachaichanin, San Diego, CA (US); Edward Leo Foley, Redmond, WA (US)

(21) Appl. No.: 18/859,152

(22) PCT Filed: May 4, 2023
(86) PCT No.: PCT/US2023/021015

§ 371 Date: Oct. 22, 2024

Related U.S. Application Data
(60) Provisional application No. 63/338,345, filed on May 4, 2022.

(51) Int. Cl. G06F 3/01

(52) U.S. Cl. CPC G06F 3/014; G06F 3/016

(57) ABSTRACT

A human-computer interface may include a compressor housing, a brake, a multi-channel pneumatic connector, a haptic glove counterpressure assembly, a haptic peripheral assembly, and/or a compressor assembly. The compressor assembly may include a housing, a first compressor, a second compressor, and an outlet portion. The housing defines a first end and a second end opposing the first end, the first compressor is disposed at the first end of the housing and is positioned in a first orientation, the second compressor is disposed at the second end of the housing and is positioned in a second orientation that opposes vibration of the first compressor in the first orientation, the the outlet portion provides compressed air from the compressor assembly.

### CROSS-REFERENCE TO RELATED APPLICATIONS

This application claims priority to U.S. Provisional Patent Application No. 63/338,345, filed, May 4, 2022. Each patent application referenced above is hereby incorporated by reference as if fully set forth herein in its entirety.

### FIELD

The present invention relates generally to human-machine interfaces to the hand, and more specifically to mobile human-machine interfaces to the hand with compact compressors.

### BACKGROUND

Design of immersive virtual reality human-machine interfaces to the hand is a long-standing challenge. The dexterity, sensitivity, and small size of the human hand make it extremely difficult to design a virtual reality human-computer interface that permits natural hand interaction with computer-mediated environments.

### SUMMARY

In some embodiments, the techniques described herein relate to a compressor assembly, including: a housing defining a first end and a second end opposing the first end; a first compressor disposed at the first end of the housing and positioned in a first orientation; a second compressor disposed at the second end of the housing and positioned in a second orientation that opposes vibration of the first compressor in the first orientation; and an outlet portion for providing compressed air from the compressor assembly.

In some embodiments, the techniques described herein relate to a compressor assembly, where the housing includes a main body, a top cover, and a bottom cover.

In some embodiments, the techniques described herein relate to a compressor assembly, where the main body defines a pneumatic circuit with a plurality of integral pneumatic conduits.

In some embodiments, the techniques described herein relate to a compressor assembly, further including a plurality of valves each in pneumatic communication with at least one of the plurality of integral pneumatic conduits.

In some embodiments, the techniques described herein relate to a compressor assembly, where the main body defines a first aperture and a second aperture in each of the plurality of integral pneumatic conduits.

In some embodiments, the techniques described herein relate to a compressor assembly, where each of the plurality of valves is in direct pneumatic communication with at least one of the first aperture and the second aperture of at least one of the plurality of integral pneumatic conduits.

In some embodiments, the techniques described herein relate to a compressor assembly, where the plurality of integral pneumatic conduits defines at least one sound absorbing portion configured to muffle sound traveling through the pneumatic circuit.

In some embodiments, the techniques described herein relate to a compressor assembly, further including a sound absorbing material disposed in the at least one sound absorbing portion.

In some embodiments, the techniques described herein relate to a compressor assembly, where the main body defines a first desiccant conduit and a second desiccant conduit, the first desiccant conduit defining a first aperture and a second aperture, the second desiccant conduit defining a third aperture and a fourth aperture, where the first desiccant conduit defines a first desiccant portion between the first aperture and the second aperture of the first desiccant conduit, and where the second desiccant conduit defines a second desiccant portion between the third aperture and the fourth aperture of the second desiccant conduit.

In some embodiments, the techniques described herein relate to a compressor assembly, further including: a first desiccant portion; a second desiccant portion; and a plurality of valves configured to direct a first airflow and a second airflow, the plurality of valves having: a first configuration that directs the first airflow from the first compressor and the second compressor through the first desiccant portion to the outlet portion, where the first configuration directs the second airflow from the first airflow through the second desiccant portion for desiccant drying in the second desiccant portion; and a second configuration that directs the first airflow from the first compressor and the second compressor through the second desiccant portion to the outlet portion, where the second configuration directs the second airflow from the first airflow through the first desiccant portion for desiccant drying in the first desiccant portion.

In some embodiments, the techniques described herein relate to a compressor assembly, where the first compressor and the second compressor create a vacuum portion, and where the plurality of valves are configured to direct the second airflow to the vacuum portion in the first configuration and in the second configuration.

In some embodiments, the techniques described herein relate to a compressor assembly, where the first configuration directs the second airflow beginning at the first airflow after the first airflow has passed through one of the first desiccant portion and the second desiccant portion.

In some embodiments, the techniques described herein relate to a compressor assembly, further including at least one of a third desiccant portion and a fourth desiccant portion, and where the plurality of valves are further configured to direct the second airflow through one of the at least one of the third desiccant portion and the fourth desiccant portion.

In some embodiments, the techniques described herein relate to a compressor assembly, where the first configuration and the second configuration direct the second airflow beginning at the first airflow before the first airflow passes through either of the first desiccant portion or the second desiccant portion.

In some embodiments, the techniques described herein relate to a compressor assembly, where the first compressor and the second compressor are configured to cooperatively energize for out of phase vibration cancelation.

In some embodiments, the techniques described herein relate to a compressor assembly, further including a strap system for the housing.

In some embodiments, the techniques described herein relate to a compressor assembly, where the strap system is a backpack strap system.

In some embodiments, the techniques described herein relate to a compressor assembly, where the strap system further includes an attachment feature configured to accommodate removal and re-installation of the strap system.

In some embodiments, the techniques described herein relate to a haptic peripheral assembly, including: a substrate having a wearable shape configured to be worn by a user; a tactile panel secured to the substrate, the tactile panel including a first tactor and a second tactor that are independently pneumatically actuated; and a multi-channel pneumatic connector configured to form a removable pneumatic coupling to accommodate assembly and disassembly of the haptic peripheral assembly with a drive system, the multi-channel pneumatic connector including: a connector body defining a first pneumatic conduit in pneumatic communication with the first tactor and a second pneumatic conduit in pneumatic communication with the second tactor; and an alignment feature configured to indicate a correct alignment of the connector body with complementary connectors to promote correct mapping of the first tactor and the second tactor with the drive system.

In some embodiments, the techniques described herein relate to a haptic peripheral assembly, further including a counterpressure assembly secured to the substrate and configured to provide counterpressure during actuation of at least one of the first tactor or the second tactor.

In some embodiments, the techniques described herein relate to a haptic peripheral assembly, further including: a position sensor secured to the substrate; and an electrical connector configured to removably couple with a drive system electrical connection to accommodate assembly and disassembly of the haptic peripheral assembly with the drive system.

In some embodiments, the techniques described herein relate to a haptic peripheral assembly, where the wearable shape is a glove shape configured to accommodate a hand of the user.

In some embodiments, the techniques described herein relate to a haptic peripheral assembly, where the tactile panel is a first finger panel configured to provide haptic feedback to a finger of the hand.

In some embodiments, the techniques described herein relate to a haptic peripheral assembly, further including: a second finger panel including a first tactor and a second tactor; a third finger panel including a first tactor and a second tactor; a fourth finger panel including a first tactor and a second tactor; a fifth finger panel including a first tactor and a second tactor; and a palm panel including a first tactor and a second tactor, where the connector body of the multi-channel pneumatic connector defines a respective pneumatic conduit for each of the first tactor and the second tactor of each of the second finger panel, the third finger panel, the fourth finger panel, the fifth finger panel, and the palm panel.

In some embodiments, the techniques described herein relate to a haptic peripheral assembly, further including five thimble components and five manipulation actuators, the five thimble components each secured to the substrate at a respective finger portion of the substrate, the five manipulation actuators each including a force transmission element secured to a respective thimble of the five thimble components for independent force feedback to the five thimble components.

In some embodiments, the techniques described herein relate to a haptic peripheral assembly, further including an opisthenar assembly secured to the substrate at an opisthenar portion, and where the five manipulation actuators are secured to the opisthenar assembly.

In some embodiments, the techniques described herein relate to a haptic peripheral assembly, where the five manipulation actuators each include a selectively coupled Hirth joint.

In some embodiments, the techniques described herein relate to a haptic peripheral assembly, where the five manipulation actuators are each pneumatically actuated.

In some embodiments, the techniques described herein relate to a haptic peripheral assembly, where the multi-channel pneumatic connector defines a plurality of pneumatic conduits for removably pneumatically coupling the five manipulation actuators to a drive unit.

In some embodiments, the techniques described herein relate to a haptic peripheral assembly, further including a wrist assembly, where the multi-channel pneumatic connector is secured to the wrist assembly.

In some embodiments, the techniques described herein relate to a haptic peripheral assembly, where the multi-channel pneumatic connector is a bottom manifold configured to couple with a top manifold to form the removable pneumatic coupling.

In some embodiments, the techniques described herein relate to a haptic peripheral assembly, further including five finger position sensors and a finger position printed circuit board assembly configured to indicate positions of the five finger position sensors.

In some embodiments, the techniques described herein relate to a haptic peripheral assembly, further including at least one flexible printed circuit connected to the finger position printed circuit board assembly, and where the five finger position sensors are disposed on the at least one flexible printed circuit.

In some embodiments, the techniques described herein relate to a haptic glove counterpressure assembly, including: a glove substrate defining a phalangeal palmar portion and a fingernail portion; a silicone panel including a plurality of tactors disposed at the phalangeal palmar portion; and a thimble assembly secured to the glove substrate at the fingernail portion and configured to receive the silicone panel for transmitting counterpressure from actuation of the plurality of tactors to a fingernail of a user.

In some embodiments, the techniques described herein relate to a haptic glove counterpressure assembly, where the silicone panel defines a pair of tabs extending laterally from the phalangeal palmar portion and configured to secure to the thimble assembly.

In some embodiments, the techniques described herein relate to a haptic glove counterpressure assembly, where the thimble assembly defines projections and the pair of tabs define through-holes configured to receive the projections to secure the tabs to the thimble assembly.

In some embodiments, the techniques described herein relate to a haptic glove counterpressure assembly, where the thimble assembly includes a puck that defines the projections and is secured to the glove substrate.

In some embodiments, the techniques described herein relate to a haptic glove counterpressure assembly, where the thimble assembly further includes a position sensor and a cable strain relief for a cable of the position sensor.

In some embodiments, the techniques described herein relate to a haptic glove counterpressure assembly, where the thimble assembly further includes a thimble secured to the puck and clamping the position sensor to the thimble assembly.

In some embodiments, the techniques described herein relate to a haptic glove counterpressure assembly, further including a clip disposed between the thimble and the puck and configured to clamp a force transmission element to the thimble assembly.

In some embodiments, the techniques described herein relate to a haptic glove counterpressure assembly, further including at least one guide secured to the glove substrate and configured to guide the force transmission element.

In some embodiments, the techniques described herein relate to a haptic glove counterpressure assembly, further including the force transmission element clamped to the thimble assembly by the clip and partially disposed within a cavity of the at least one guide.

In some embodiments, the techniques described herein relate to a haptic glove counterpressure assembly, where the puck and the at least one guide are glued to the glove substrate.

In some embodiments, the techniques described herein relate to a haptic glove counterpressure assembly, where the puck and the at least one guide are riveted to the glove substrate.

In some embodiments, the techniques described herein relate to a multi-channel pneumatic connector for a human-computer interface, the multi-channel pneumatic connector including: a tubing connector body defining a plurality of air channels, the plurality of air channels each defining: a tubing receiving portion; a face seal aperture in pneumatic communication with the tubing receiving portion; and a glue receiving portion adjacent to the tubing receiving portion; a plurality of pneumatic tubes each extending through the glue receiving portion and partially disposed within the tubing receiving portion of one of the plurality of air channels; and glue disposed in the glue receiving portion of each of the plurality of air channels.

In some embodiments, the techniques described herein relate to a multi-channel pneumatic connector, where the tubing receiving portion is substantially cylindrically shaped with a diameter that is substantially the same as an outer diameter of a respective one of the plurality of pneumatic tubes.

In some embodiments, the techniques described herein relate to a multi-channel pneumatic connector, where the glue receiving portion has an increasing cross-section area extending away from the tubing receiving portion.

In some embodiments, the techniques described herein relate to a multi-channel pneumatic connector, where the glue receiving portion has a substantially conical shape.

In some embodiments, the techniques described herein relate to a multi-channel pneumatic connector, where the face seal aperture of each of the plurality of air channels is configured to connect to a face seal aperture of a complementary connector component.

In some embodiments, the techniques described herein relate to a multi-channel pneumatic connector, where the tubing connector body is configured to connect to a pneumatically actuated tactile panel.

In some embodiments, the techniques described herein relate to a multi-channel pneumatic connector, where the tubing connector body is configured to connect to a manifold of a pneumatic human-computer interface drive unit.

In some embodiments, the techniques described herein relate to a multi-channel pneumatic connector, where the tubing connector body is configured to connect to a replaceable assembly of a human-computer interface system.

In some embodiments, the techniques described herein relate to a brake, including: a grounding assembly, including: a first component; a second component separated from and substantially fixed in position relative to the first component; a Hirth joint assembly, including: a brake pad disposed between the first component and the second component, the brake pad defining a first braking surface with substantially triangular teeth; and a braked component disposed between the brake pad and one of the first component and the second component, the braked component defining a second braking surface with substantially triangular teeth opposing the first braking surface; and an actuator disposed between the Hirth joint assembly and one of the first component and the second component, the actuator configured to expand to selectively bias the brake pad and the braked component together, the actuator further configured to accommodate a yielding translation based on a predetermined brake design holding force.

In some embodiments, the techniques described herein relate to a brake, where the first component secures to the second component to form a housing for the brake.

In some embodiments, the techniques described herein relate to a brake, where the second component defines a cavity, and where the brake pad and the braked component are disposed in the cavity.

In some embodiments, the techniques described herein relate to a brake, where the actuator is a bladder.

In some embodiments, the techniques described herein relate to a brake, where the bladder is a pneumatic bladder configured to actuate by inflation from a compressed gas, and where the actuator is configured to accommodate the yielding translation based at least in part on a compression of the compressed gas.

In some embodiments, the techniques described herein relate to a brake, further including a force transmission element, where the braked component is a spool configured to accommodate winding of the force transmission element.

In some embodiments, the techniques described herein relate to a brake, where the force transmission element is a tendon for an exoskeleton force feedback system.

In some embodiments, the techniques described herein relate to a brake, where the predetermined brake design holding force is based on limiting component breakage in the exoskeleton force feedback system.

In some embodiments, the techniques described herein relate to a brake, further including a power spring biasing the spool to a retracted position of the force transmission element.

In some embodiments, the techniques described herein relate to a brake, where the first component and the second component are configured to secure together to form a housing, and where the housing defines a snap install feature for installation into an assembly.

In some embodiments, the techniques described herein relate to a wireless pneumatic haptic feedback system, including: a drive unit including: an enclosure; a battery disposed in the enclosure; a wireless data communication device; a compressor; and a backpack strap assembly configured to secure to the enclosure and to hold the enclosure against a human body; and a peripheral assembly pneumatically coupled with the drive unit.

### DETAILED DESCRIPTION

Haptic feedback gloves have broad commercial applications, including in entertainment, medical and industrial training, and computer-aided design and manufacturing. The human-computer interfaces described herein have generality, realism, and practicality.

Generality refers to human-computer interfaces with general applicability and have improved flexibility, adaptability, and economy of scale over conventional human-computer interfaces.

Realism refers to realistic touch sensation with multiple sensory modalities for natural interaction, such as cutaneous feedback (mechanical stimulation of the skin) and kinesthetic feedback (net forces applied to the musculoskeletal system). This realism is due, in part, to the resolution, displacement, frequency response, force output, and other performance characteristics to realistically stimulate a particular sensory modality as described herein.

Practicality refers to a light and low-profile design that is comfortable enough to be worn on the hand, and robust enough to survive repeated use in a real-world environment. Features described herein lower the cost of the human-computer interface to promote commercial practicality. Even more features described herein increase the speed at which gloves of the human-computer interface may be donned and doffed.

As used herein, the term “haptic feedback glove” means: a hand portion of a human-computer interface garment. As used herein, the term “finger” means: a digit of the hand, including the thumb. “Digit” and “finger” are used interchangeably throughout the present application. As used herein, the term “mechanical ground” means: a point that is substantially fixed and immovable with respect to a finger of the user. As used herein, the term “position sensor” means: a sensor configured to detect at least one of position and orientation.

### Overview of Human-Computer Interface System

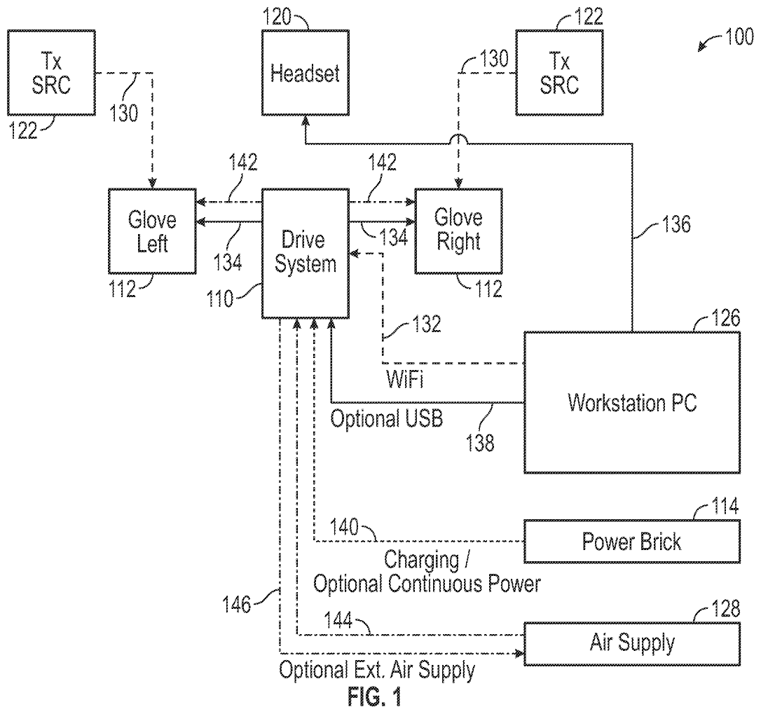

Referring now to FIG. 1, a schematic diagram illustrates a human-computer interface system 100 in accordance with the teachings of the present disclosure. Human-computer interface system 100 includes a drive system 110, gloves 112 for the left and right hands, a power supply 114, a headset 120, transmission sources 122, a workstation 126, and an external air supply 128.

Human-computer interface system 100 may be operated in a wireless configuration or in a wired configuration. The wireless configuration uses wireless data communication and a battery to provide power. The wired configuration uses an optional power connection for indefinite operation, an optional USB connection for data communication, and an optional external pneumatic connection for providing additional compressed air.

Drive system 110 includes an air supply, a battery, valves, and electronics to support operation of human-computer interface system 100, as will be described below. The electronics selectively actuate the valves to control the flow of air to each of gloves 112.

Drive system 110 is wearable on the body of the user and the components of drive system 110 include features that reduce the weight, size, cost, and noise of drive system 110 relative to conventional systems, as described below.

Gloves 112 provide haptic feedback to the left and right hands of the user while permitting finger and wrist movement. Gloves 112 include features such as soft thimbles and manipulation actuators that are improvements over conventional haptic feedback gloves, as discussed below.

In some embodiments, gloves 112 include an inner glove or interface layer and an outer glove or veneer layer, as illustrated below. An undersuit glove may be donned by the user before donning gloves 112 to prevent direct skin contact between the user and the inside of the haptic feedback glove. The use of an undersuit glove reduces the need to clean the haptic feedback glove and offers improved hygiene, particularly in cases where a single haptic feedback glove is shared between multiple users.

Power supply 114 may be any suitable electrical power conversion component to couple available electrical power and electronics of drive system 110. For example, power supply 114 may convert 240 volt split phase or 120 volt single phase alternating current electrical power into 24 volt direct current electrical power for use by drive system 110.

Headset 120 may be any visual interface or display capable of presenting visual images to the user of human-computer interface system 100. In the example provided, headset 120 is an immersive reality headset, which may be commercially described as a virtual reality headset, augmented reality headset, or mixed reality headset.

Transmission sources 122 may be used to communicate external data to gloves 112.

Workstation 126 may be any computer capable of running software to simulate a virtual environment. In the example provided, workstation 126 connects to drive system 110 through a wireless data network.

External air supply 128 may be any source of pressurized air or other inert gas. For example, external air supply 128 may be a separate compressor or pressurized gas supply.

In the example provided, drive system 110, gloves 112, and power supply 114 are packaged together to be acquired by users as a single product. In such an example, the headset 120, transmission sources 122, workstation 126 hardware, and external air supply 128 are supplied by the user using other commercially available products. In some embodiments, fewer or more of the components are provided as the single product.

Various communication paths connect the components of human-computer interface system 100. In the example provided, the communication paths include wireless data paths 130, wireless data path 132, wired data path 134, wired data path 136, wired data path 138, electrical power line 140, glove pneumatic conduits 142, external pneumatic supply conduit 144, and external pneumatic exhaust conduit 146.

It should be appreciated that any of the data paths may be wireless or wired without departing from the scope of the present disclosure. Wireless data path 130 couples transmission sources 122 with gloves 112 for communication. Wireless data path 132 couples drive system 110 with workstation 126 for communication. Wired data path 134 couples drive system 110 with gloves 112 for communication. Wired data path 136 couples headset 120 with workstation 126 for communication. In the example provided, wired data path 138 is a USB connection that couples drive system 110 with workstation 126 for communication.

Power communication line 140 may be any suitable power cable compatible with drive system 110 and power supply 114. Glove pneumatic conduits 142 may be any suitable pneumatic conduits (e.g., flexible tubing) capable of communicating pressurized air between drive system 110 and gloves 112. External pneumatic supply conduit 144 and external pneumatic exhaust conduit 146 may be any suitable pneumatic conduits (e.g., flexible tubing) capable of communicating pressurized air between drive system 110 and external air supply 128.

### Electronics of Human-Computer Interface System

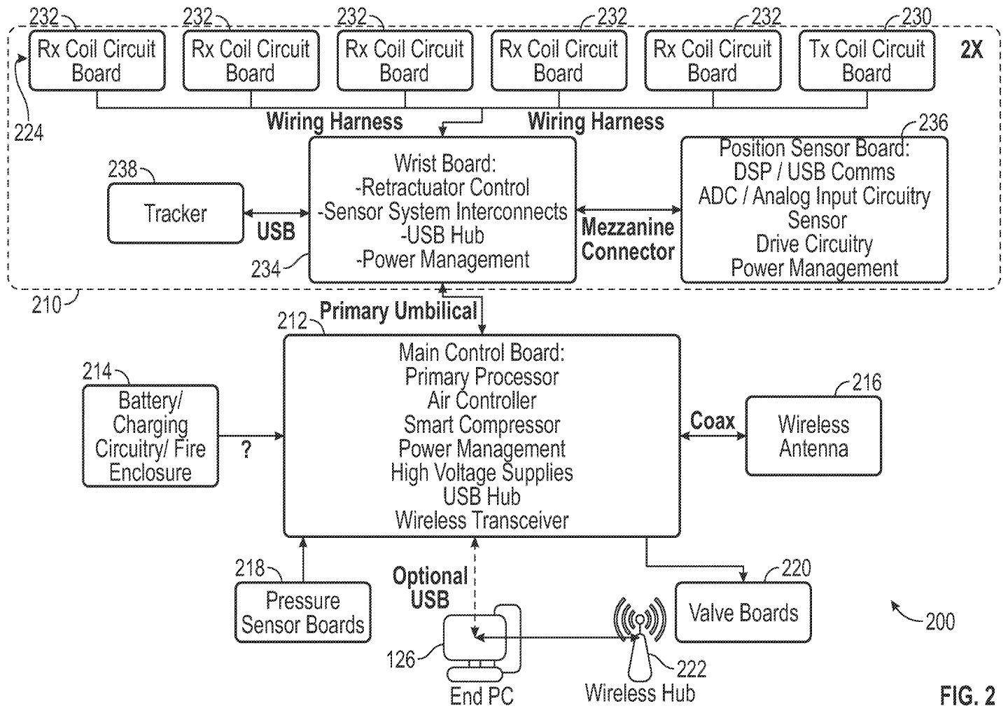

Referring now to FIG. 2, and with continued reference to FIG. 1, a schematic diagram illustrates an electronics system 200 suitable for use with the haptic glove system of FIG. 1 in accordance with the teachings of the present disclosure. Electronics system 200 includes various circuitry implemented, for example, with printed circuit boards (PCBs) and flexible printed circuit boards (FPCBs or FCBs).

Electronics system 200 includes a peripheral assembly 210, a main control board 212, battery management circuitry 214, a wireless antenna 216, a pressure sensor board 218, valve boards 220, workstation 126, and a wireless hub 222.

Peripheral assembly 210 includes a position sensor system 224, peripheral circuitry 234, and a motion tracker 238.

Position sensor system 224 includes position sensors 232, magnetic emitter 230, and position sensor circuitry 236. Position sensors 232 are receiving coil sensors that receive a magnetic field emitted by magnetic emitter 230 to provide finger position tracking with six degrees of freedom. In some embodiments, emitter 230 is located remotely from the user.

In some embodiments, position sensor system 224 includes force sensors configured to transduce a point force on the user's skin, or a net force/torque on a digit of the user's hand to enable closed loop force control. In some embodiments, position sensors 232 and magnetic emitter 230 are replaced with an optical sensor.

Position sensor circuitry 236 includes digital signal processing and USB communications, ADC/Analog input circuitry, sensor drive circuitry, and power management.

Peripheral circuitry 234 provides manipulation actuator control, position sensor interconnects, a USB hub, and power management.

Motion tracker 238 provides absolute position of the hand. For example, motion tracker 238 may provide the absolute position of the hand in space, while the magnetic emitter 230 and position sensor 232 provide finger positioning relative to the absolute position. Motion tracker 238 may be any commercially available motion tracker, such as the VIVE tracker commercially available from HTC.

Main control board 212 is disposed in drive system 110. Main control board 212 includes a primary processor, a high voltage power supply, an air controller, power management, a US hub, and a wireless transceiver.

Battery management circuitry 214 controls charging and discharging monitoring and control of a battery of drive system 110. In the example provided, battery management circuitry 214 is enclosed in a fire enclosure with the battery. In some embodiments, battery management circuitry 214 and the battery are configured to manage power consumption of about 20W to about 40W for greater than four hours of use of human-computer interface system 100.

Wireless antenna 216 receives wireless signals for data communication and passes the wireless signals to main control board 212, such as by a coaxial cable.

Pressure sensor board 218 measures the pressure at various locations in human-computer interface system 100. Valve boards 220 provide actuation control of valves within drive system 110. In the example provided, valve boards 220 manage 118 Air Channels with one microcontroller used for every two channels.

### Production Test Flow for Human-Computer Interface System

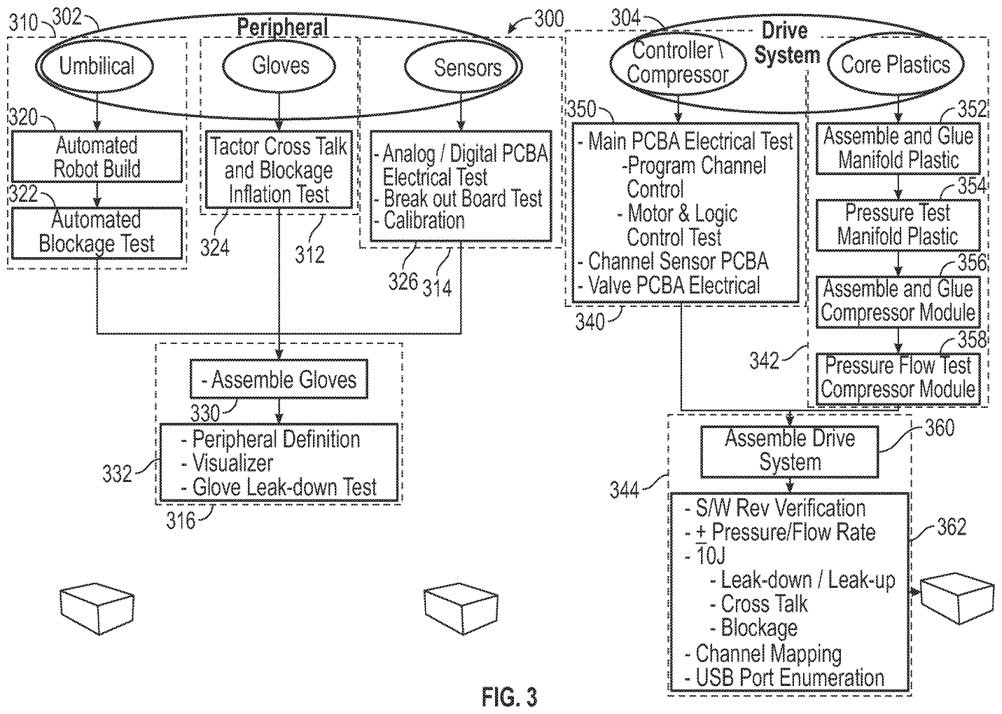

Referring now to FIG. 3, and with continued reference to FIGS. 1-2, a simplified flow diagram illustrates a production test flow 300 in accordance with the teachings of the present disclosure. Production test flow 300 includes a peripheral test flow 302 and a drive system test flow 304.

Peripheral test flow 302 includes umbilical process 310, glove process 312, position sensor process 314, and peripheral assembly process 316. Umbilical process 310 includes an umbilical build task 320 and a blockage test 322.

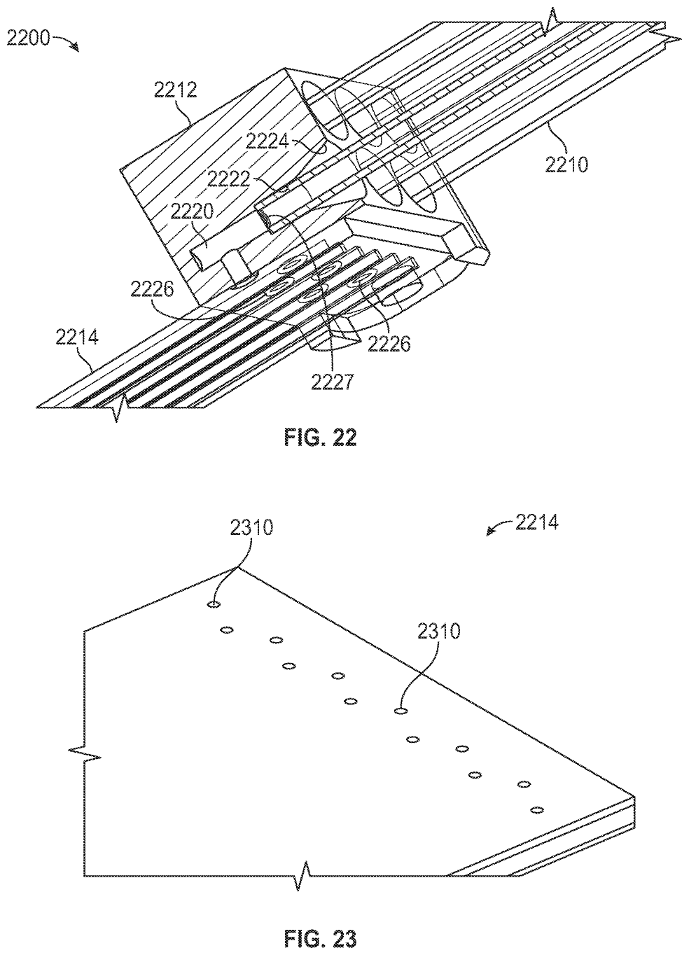

Umbilical build task 320 utilizes an automated robot to assemble tubing within connectors of a multi-channel pneumatic connector in an umbilical that will connect drive system 110 with gloves 112. For example, the robot may assemble the tubing as discussed below with reference to FIGS. 22-23. In some embodiments, the automated robot is a six-axis automated robot. In the example provided, in a first task of umbilical build task 320, a three-axis robot places the multi-channel pneumatic connector and a top manifold of a wrist mount assembly in a holding device or nest. In a second task of umbilical build task 320 of the example provided, a six-axis robot pulls tubing from a spool to the designed length and pinches the tubing with fixturing to hold firmly at the measured length. In a third task of umbilical build task 320 of the example provided, a pivoting and retractable blade cuts the tubing. In a fourth task of umbilical build task 320 of the example provided, a six-axis robot places a first end of the tube vertically down into the multi-channel pneumatic connector and other end of the tube into the wrist mount top manifold. In a fifth task of 320 of the example provided, a two-axis robot applies glue to both end pieces. In a sixth task of umbilical build task 320 of the example provided, a three-axis robot removes the assembly from the holding device or nest. In the example provided, umbilical build task 320 makes 60 connections.

Blockage test 322 measures air movement through pneumatic conduits between end points of an umbilical that will connect drive system 110 with gloves 112.

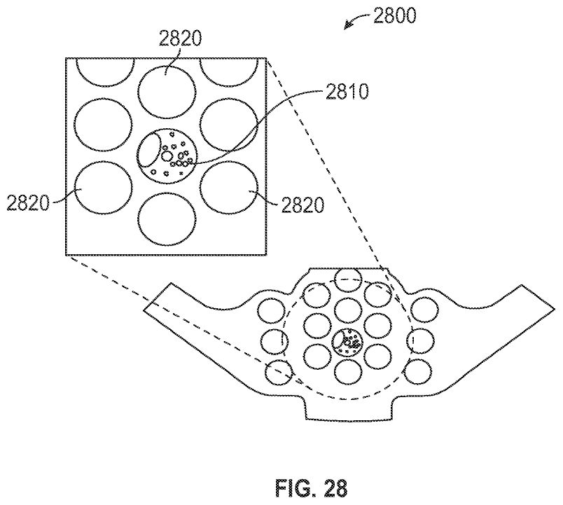

Glove process 312 includes an inflation test 324 for identifying tactor cross-talk and inflation problems. For example, glove process 312 may utilize the computer vision testing further discussed with reference to FIG. 28 below.

Position sensor process 314 includes electrical testing and calibration 326. For example, the electrical testing may include analog and/or digital printed circuit board assembly electrical testing, break out board testing, and calibration of the position sensor.

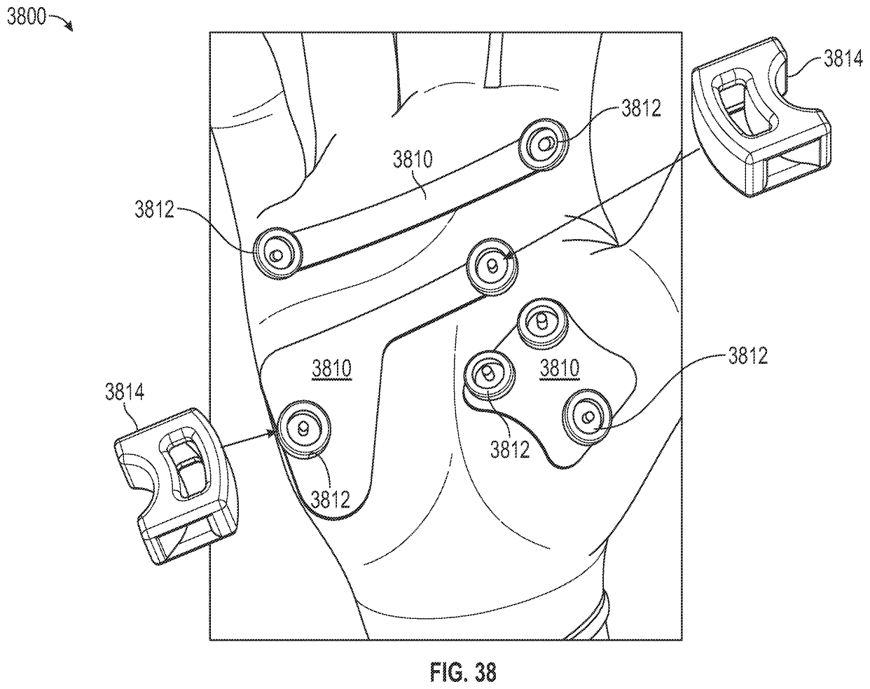

Peripheral assembly process 316 includes a glove assembly task 330 and a peripheral completion task 332. Glove assembly task 330 assembles gloves 112 as will become apparent with reference to FIGS. 38-46 below. Peripheral completion task 332 may include peripheral definition, position sensor visualizer, and glove leak-down testing.

Drive system test flow 304 includes controller process 340, core plastics process 342, and drive system assembly process 344.

Controller process 340 includes electrical testing 350. For example, electrical testing 350 may include main PCBA electrical tests, channel sensor PCBA tests, and valve PCBA electrical tests. In some embodiments, a main PCBA electrical test includes program channel control and motor and logic control tests.

In the example provided, electrical testing 350 includes electronic design verification tests for drive system 110. Electrical testing 350 includes at least: a WiFi Functional Test, pairing, range, interference immunity, USB communication, communication functionality, and bootload functionality. In the example provided, electrical testing 350 includes drive channel functional and performance verification for frequency response, stability, and power on/off.

In the example provided, electrical testing 350 for the compressor includes functional and performance verification for frequency response, stability, and power consumption. In the example provided, electrical testing 350 for the display functional and performance verification includes display tests and wake/sleep verification.

In the example provided, electrical testing 350 for power management includes voltage supply verification, current limiting, and supply on/off timing. In the example provided, electrical testing 350 for primary processor functionality includes log file read/write, reset, and peripherals/communication buses. In the example provided, electrical testing 350 for safety and compliance includes high voltage cutoff (case open), current Limiting/in-rush current, EMC/ESD pre-scan of prototypes, and thermal cutoff/shutdown.

Core plastics process 342 includes an assembly task 352 to assemble and glue manifold plastics, a pressure test 354 for the assembled manifold plastics, an assembly task 356 to assemble and glue the compressor module, and a pressure flow test 358 for the compressor module.

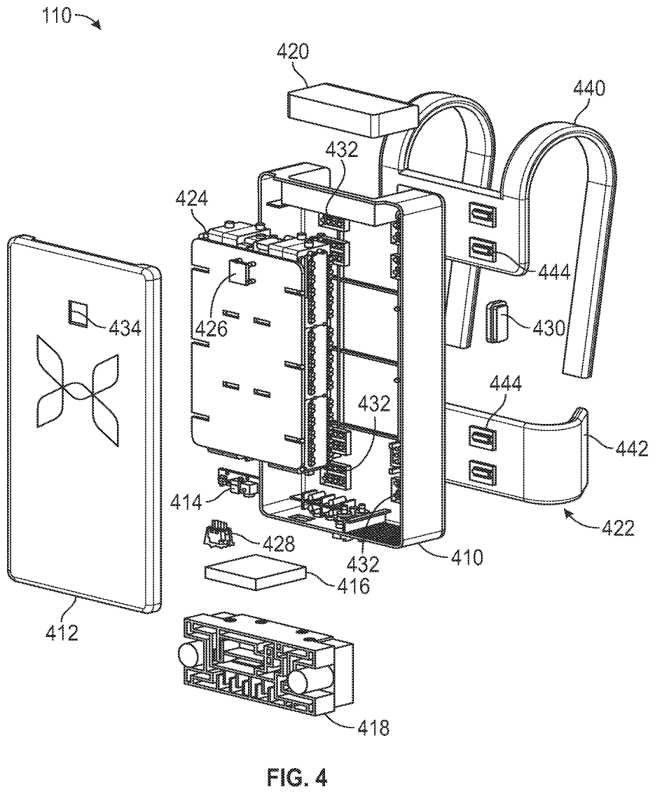

Drive system assembly process 344 includes an assembly task 360 and a drive system completion task 362. Assembly task 360 includes assembly of the drive system, as will become apparent with reference to FIG. 4 below. Drive system completion task 362 may include software revision verification, adjustment of pressure and flow rate, lead-down and leak-up testing, cross-talk testing, blockage testing, channel mapping, and USB port enumeration.

### Drive System

Referring now to FIG. 4, and with continued reference to FIGS. 1-3, components of drive system 110 are illustrated in an exploded view in accordance with the teachings of the present disclosure.

Drive system 110 includes a bottom enclosure 410, a top enclosure 412, an input/output board 414, a fan 416, a compressor 418, a battery 420, a strap system 422, a valve core 424, an LCD display 426, a power switch 428, and a glove connector 430.

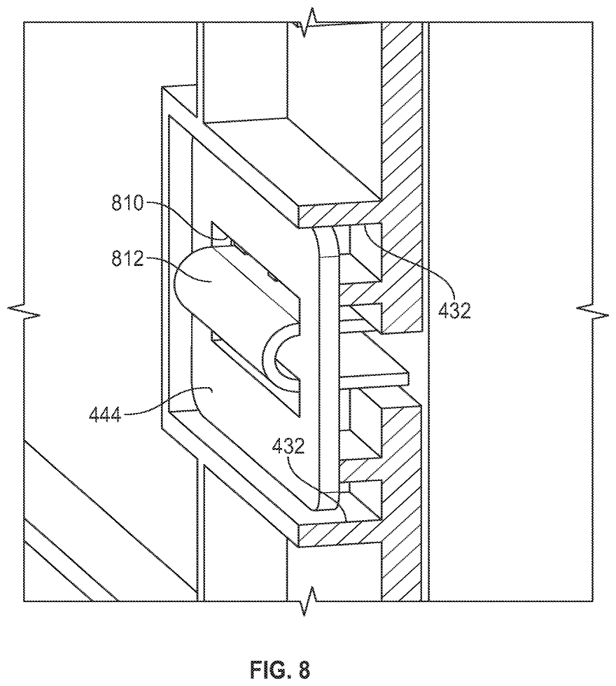

Bottom enclosure 410 defines a cavity into which other components of drive system 110 may be placed. For example, bottom enclosure 410 may integrate valve core 424, compressor 418, battery 420, multi-channel pneumatic connectors (not shown in FIGS. 4-8), fan 416, and strap system 422. In the example provided, valve core 424, compressor 418, and fan 416 are captured in features defined by bottom enclosure 410. Bottom enclosure 410 further defines slots 432, as can best be seen in FIG. 8 and are described below.

Top enclosure 412 secures to bottom enclosure 410 to enclose and protect the components in a housing or case. For example, top enclosure 412 may secure to bottom enclosure 410 with four to eight short screws to promote serviceability. Top enclosure 412 further defines a window 434.

Input/output board 414 includes connections for data, power, and control. In the example provided, output board 414 has a USB-Type B port, power supply port, and on/off buttons. Fan 416 moves air through drive system 110 to cool components within the housing.

Strap system 422 includes an attachable and detachable set of straps, as discussed below with reference to FIG. 8. The straps include a padded shoulder strap 440 and padded hip strap 442. Padded shoulder strap 440 includes padded arm straps that extend from an upper padded section to padded hip strap 442. Padded hip strap 442 interfaces with bottom enclosure 410 using metal plates 444 that slip through slots in the Bottom Enclosure, as will be discussed below with reference to FIG. 8.

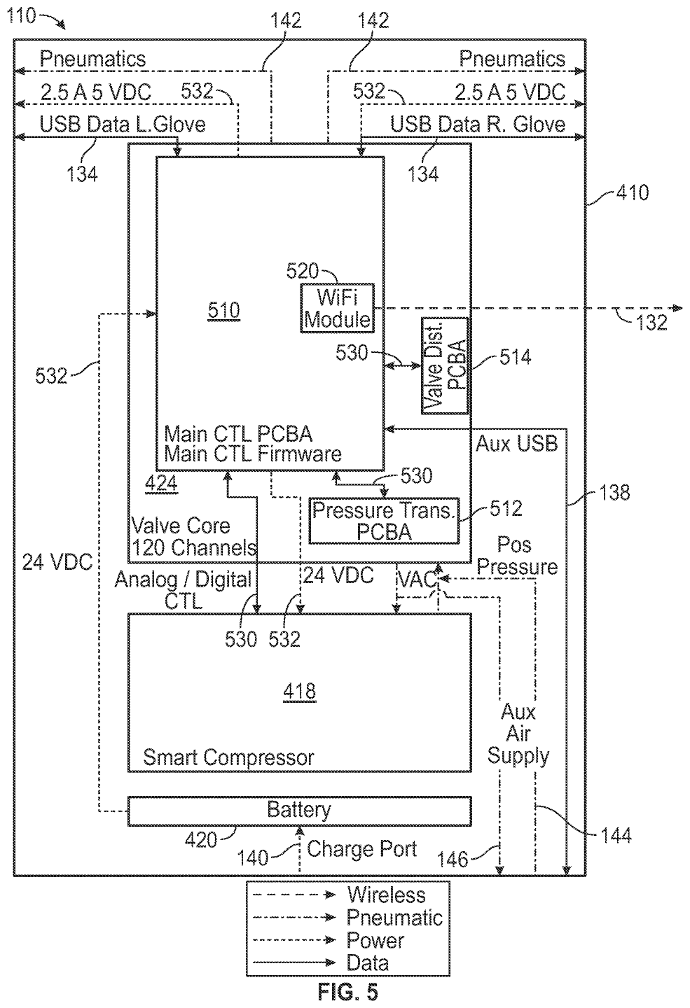

Referring now to FIG. 5, and with continued reference to FIGS. 1-4, a block diagram illustrates additional wiring and electronics of drive system 110 in accordance with the teachings of the present disclosure. Drive system 110 further includes a main control board 510, a pressure transducer PCBA 512, and a valve distribution PCBA 514. Main control board 510 includes a wireless networking module 520 (e.g., Wi-Fi).

Main control board 510 includes wireless networking module 520 for wireless data communication, such as by Wi-Fi. Pressure transducer PCBA 512 measures pressure within various parts of drive system 110. Valve distribution PCBA 514 controls pneumatic valves of drive system 110, as shown below. The electronics of drive system 110 communicate across various data communication paths 530 internal to drive system 110 and are powered by various low voltage DC power paths 532 internal to drive system 110.

### Valve Core—Compressor Assembly

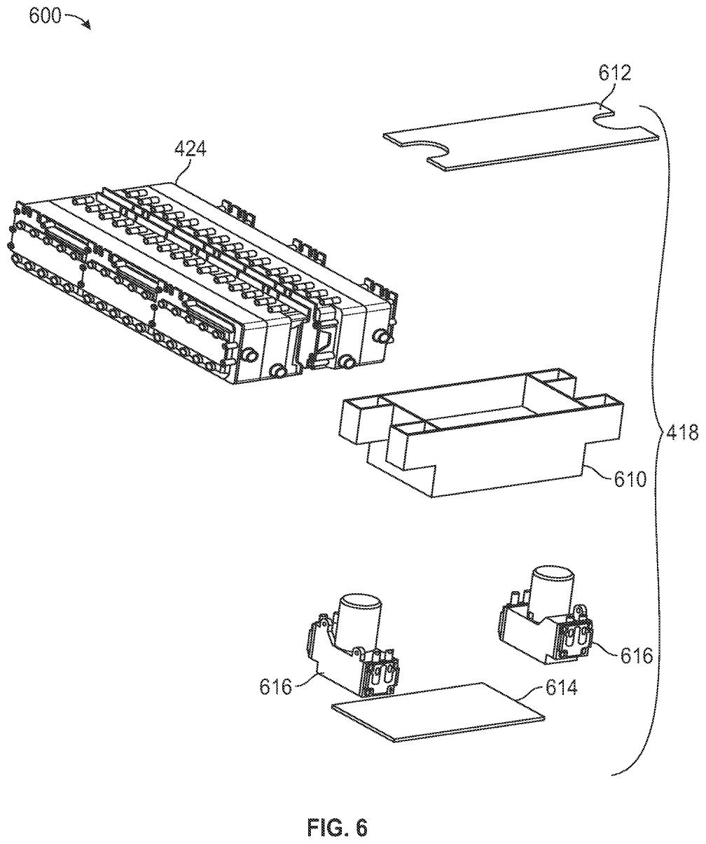

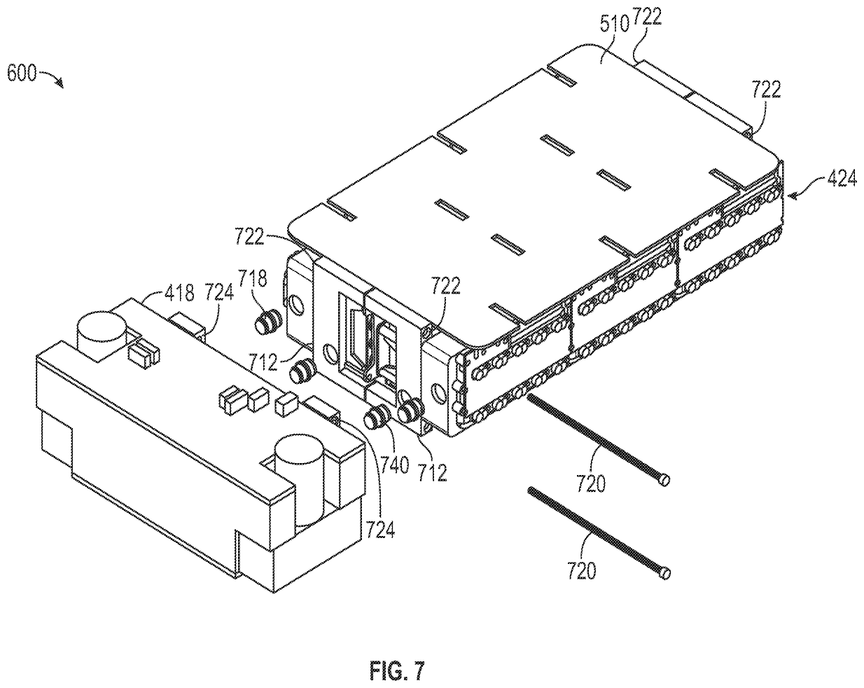

Referring now to FIGS. 6-7, and with continued reference to FIGS. 1-5, a valve core-compressor assembly 600 is illustrated in exploded views with compressor 418 in relation to valve core 424.

Compressor 418 includes pneumatic circuit body 610, top cover 612, bottom cover 614, and two diaphragm pumps 616. Valve core 424 includes two manifold assemblies 712 and is coupled to compressor with gasketed channels 710 and tie rods 720. In the example provided, valve core 424 defines tie rod through-holes 722 and pneumatic circuit body 610 defines tie rod through-holes 722 through which tie rods 720 pass to couple valve core 424 to compressor 418.

Gasketed channels 710 insert into valve core 424 on one end and insert into pneumatic circuit body 610 of compressor 418 on the other end. Gasketed channels 710 permit pneumatic communication between compressor 418 and valve core 424 while restricting air leaks with O-rings 718 and attenuating vibrations from compressor 418.

The two manifold assemblies 712 are mounted together using interlocking features in the plastics further secured with screws for serviceability. Main control board 510 is mounted to the top of valve core 424 using snap arms. In the example provided, main control board 510 interfaces with the valve distribution PCBA 514 and pressure transducer PCBA 512 using board edge connectors.

### Backpack Strap Assembly

Referring now to FIG. 8, and with continued reference to FIGS. 1-7, components of a strap system are illustrated in accordance with the teachings of the present disclosure. For example, the strap system may be strap system 422 illustrated in FIG. 4.

In the example provided, metal plates 444 define slots 810 through which strap loops 812 pass. Strap loops 812 may be formed, for example, from padded shoulder strap 440 and/or padded hip strap 442. Metal plates 444 then slide into slots 432 of bottom enclosure 410 and restrict strap loops 812 from pulling away from bottom enclosure 410.

Metal plates 444, slots 810, and strap loops 812 define an attachment feature configured to accommodate removal and re-installation of strap system 422. It should be appreciated that other attachment features may be incorporated without departing from the scope of the present disclosure.

### Manifold Assemblies

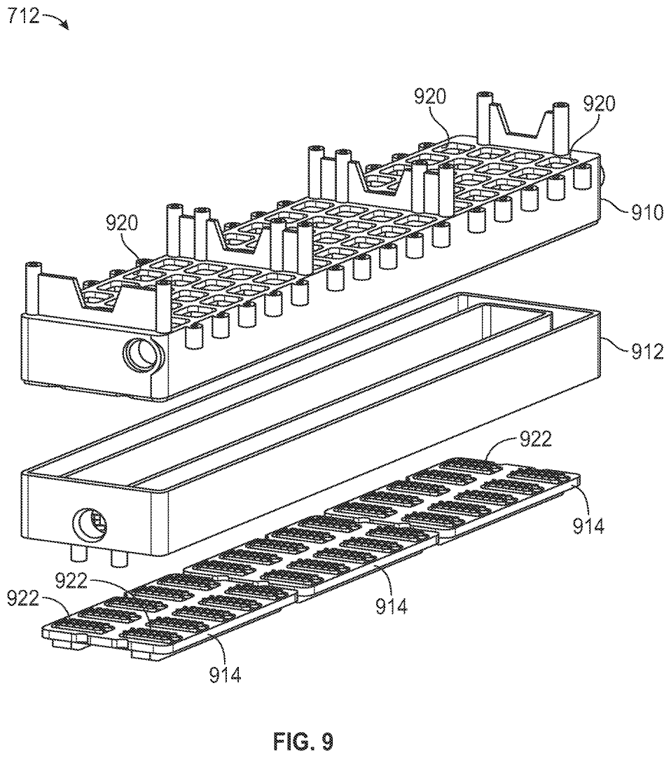

Referring now to FIGS. 9-11, exploded views illustrate manifold assemblies of a valve core in accordance with some embodiments. For example, manifold assemblies may be manifold assemblies 712 of valve core 424.

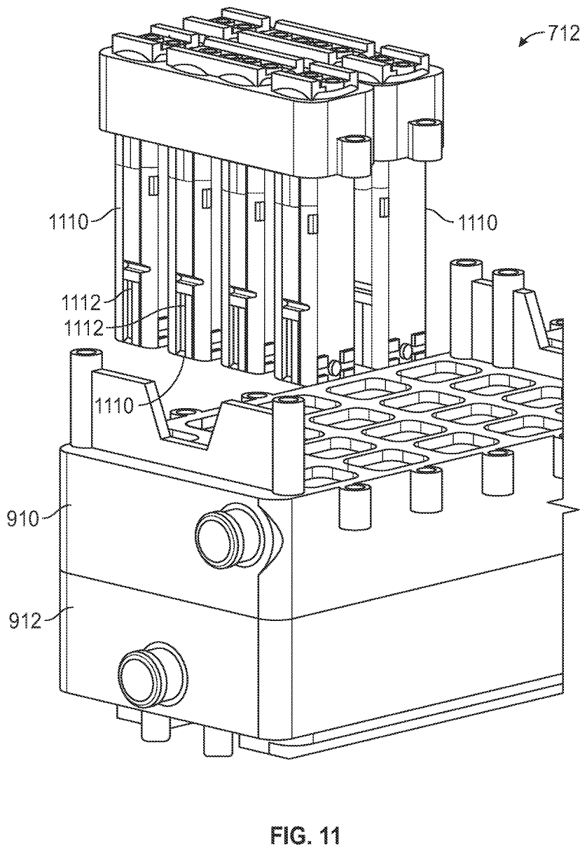

Manifold assemblies 712 each include a bottom manifold 910, a middle manifold 912, and top manifold 914. Bottom manifold 910 defines valve cavities 920 for each valve to be inserted into bottom manifold 910. Middle manifold 912 is glued to bottom manifold 910 and three of top manifolds 914. Top manifolds 914 include channel aperture portions 922 that each defines a plurality of channel apertures selectively coupled with pressurized air within manifold assemblies 712 by actuation of valves 1110 illustrated in FIG. 11.

In the example provided, bottom manifold 910, middle manifold 912, and top manifolds 914 are injection molded and glued such that manifold assemblies 712 hold a working pressure of 30 psi with a safety factor of 6×.

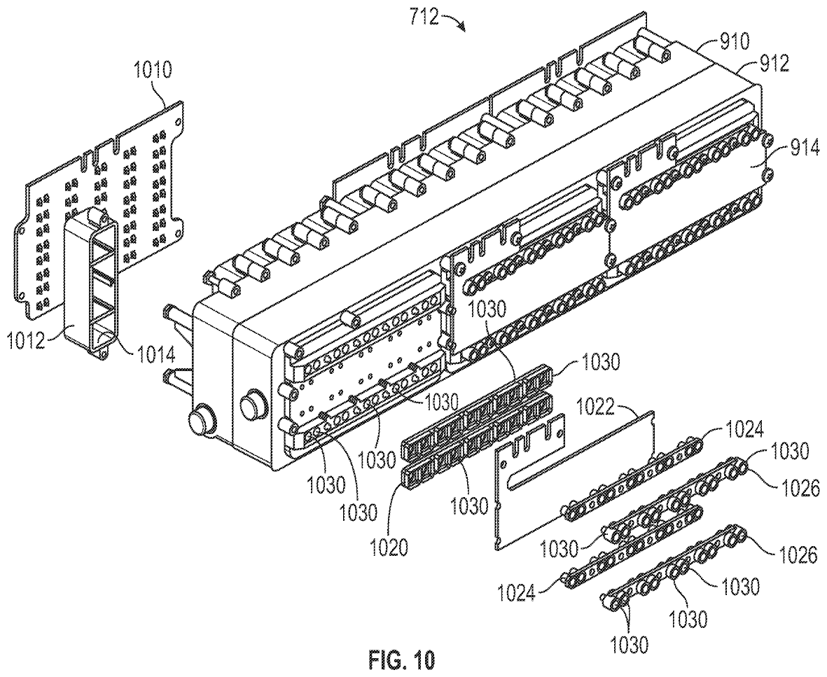

As seen in FIG. 10, valve boards 1010, valve housings 1012 defining valve cavities 1014, sensor gaskets 1020, channel sensor boards 1022, manifold connector gaskets 1024, and manifold connectors 1026 are assembled with manifold assemblies 712.

Three valve boards 1010 are connected to bottom manifold 910 with 15 valve housings 1012 collectively defining 60 valve cavities 1014 per manifold assembly 712.

Six sensor gaskets 1020, three channel sensor boards 1022, six manifold connector gaskets 1024, and six manifold connectors 1026 are coupled to manifold assembly 712.

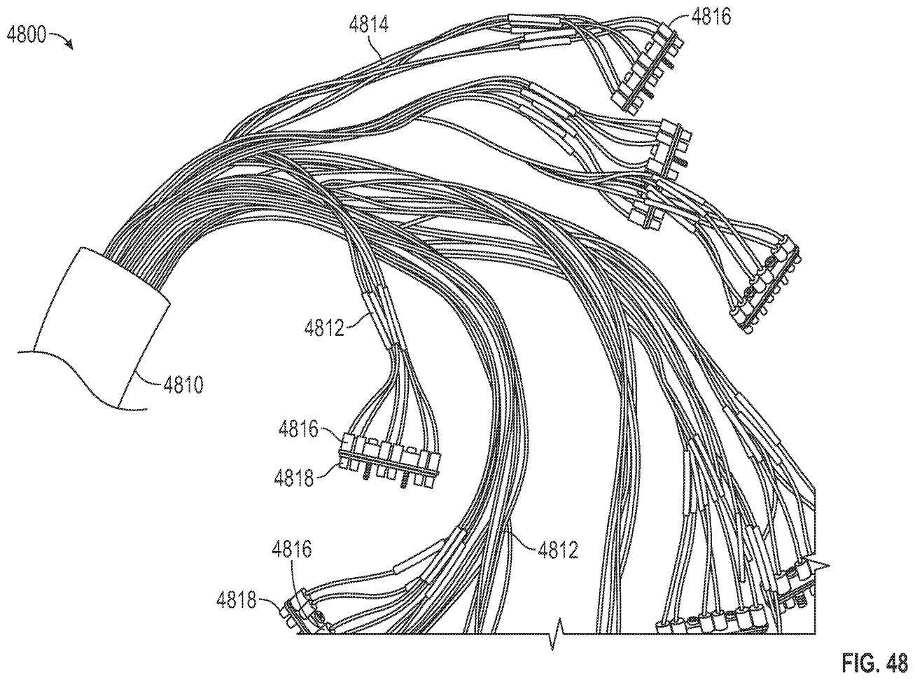

Each of top manifold 914, sensor gaskets 1020, manifold connector gaskets 1024, and manifold connectors 1026 defines channel apertures 1030. The channel apertures 1030 collectively couple the plurality of channel apertures of channel aperture portions 922 to a of tubing harness, where each channel aperture 1030 is coupled with a respective tube of a tubing harness, as best seen in FIG. 48. Accordingly, manifold assembly 712 integrates many channels very tightly and enables a very dense assembly capable of high-performance proportional balance.

As seen in FIG. 11, valves 1110 each have two electrically actuated benders 1112. Each bender selectively blocks a very small air channel of channel aperture portions 922. This arrangement forms two independent 2-2 valves for fully proportional control of the flow in each individual channel with very high fidelity.

### Compressor

### Pneumatic Flow Circuit

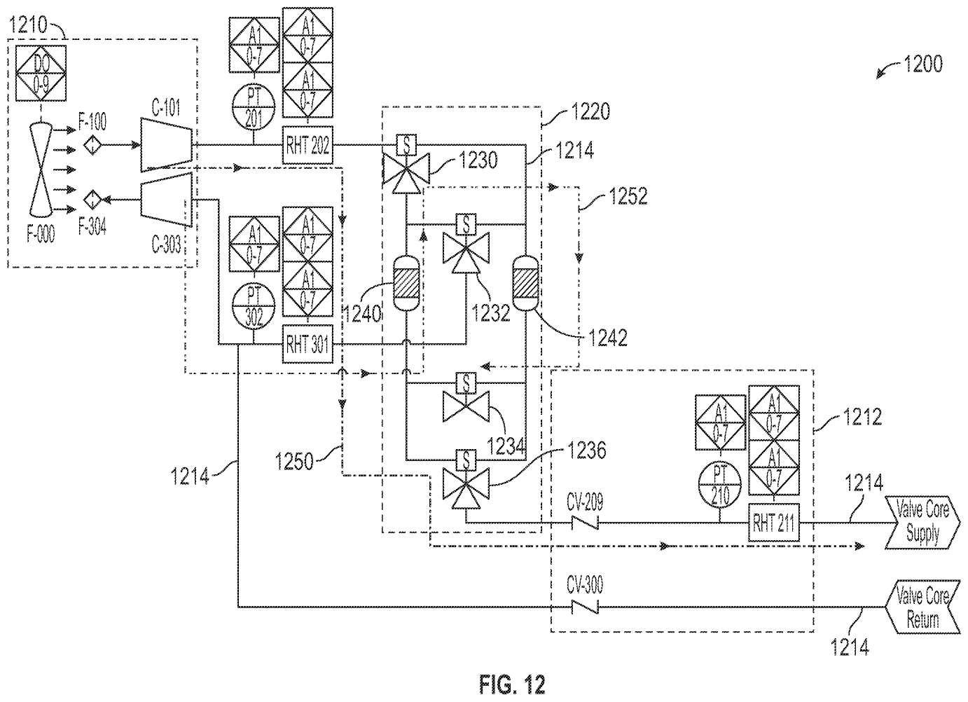

Referring now to FIG. 12, and with continued reference to FIGS. 1-11, a pneumatic diagram illustrates a pneumatic circuit 1200 for a compressor. For example, pneumatic circuit 1200 may illustrate pneumatic flow for compressor 418. Pneumatic circuit 1200 illustrates how compressor 418 uses pressure swing adsorption for pulling moisture out of the compressed air. Generally, pressurized air is passed through a desiccant where the desiccant beads will absorb water in the pressurized air. A separate airflow at a low pressure is simultaneously regenerating or taking the moisture back out of a second desiccant. In the example provided, a vacuum generated by compressor 418 creates the low pressure to regenerate the desiccant faster and more fully than would be achieved with atmospheric pressure.

Pneumatic circuit 1200 includes a compressor and cooler portion 1210, inlet/outlet portion 1212, pneumatic conduits 1214, and desiccant portion 1220. In the example provided, compressor and cooler portion 1210 includes diaphragm pumps 616. Inlet/outlet portion 1212 defines pressurized air supply and exhaust to valve core 424.

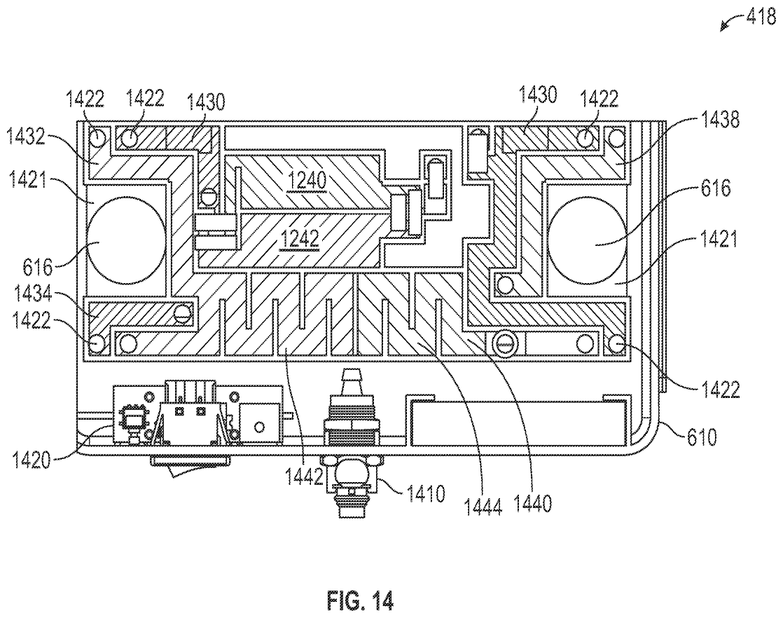

Pneumatic conduits 1214 couple the various parts of compressor 418 to each other for pneumatic communication. In the example provided, pneumatic conduits 1214 are at least partially defined by pneumatic circuit body 610, as will be described below with reference to FIG. 14.

Desiccant portion 1220 includes a first valve 1230, a second valve 1232, a third valve 1234, a fourth valve 1236, a first desiccant portion 1240, and a second desiccant portion 1242. Desiccant portion 1220 provides dry air to valve core 424 with use of one of first desiccant portion 1240 or second desiccant portion 1242 while regenerating the other of first desiccant portion 1240 or second desiccant portion 1242 for continuous flow of dry air.

The valves 1230, 1232, 1234, 1236 operate to selectively provide a usable airflow 1250 and a desiccant regeneration airflow 1252. For the airflows illustrated with a first valve configuration, first valve 1230 directs usable airflow 1250 from compressor and cooler portion 1210 to first desiccant portion 1240 and fourth valve 1236 directs usable airflow 1250 from first desiccant portion 1240 to valve core 424. For desiccant regeneration airflow 1252, third valve 1234 directs some bypass air from usable airflow 1250 through second desiccant portion 1242 and second valve 1232 directs desiccant regeneration airflow 1252 to a vacuum of compressor and cooler portion 1210. Accordingly, usable airflow 1250 provides a steady stream of dry air using first desiccant portion 1240 while desiccant regeneration airflow 1252 dries second desiccant portion 1242.

When first desiccant portion 1240 becomes saturated, usable airflow 1250 and desiccant regeneration airflow 1252 may be directed along different paths by a second valve configuration (not illustrated). For example, first valve 1230 may direct usable airflow 1250 from compressor and cooler portion 1210 to second desiccant portion 1242 and fourth valve 1236 may direct usable airflow 1250 from second desiccant portion 1242 to valve core 424. In this configuration, third valve 1234 may direct desiccant regeneration airflow 1252 as bypass air from usable airflow 1250 to first desiccant portion 1240 and second valve 1232 may direct desiccant regeneration airflow 1252 from first desiccant portion 1240 to the exhaust of compressor and cooler portion 1210.

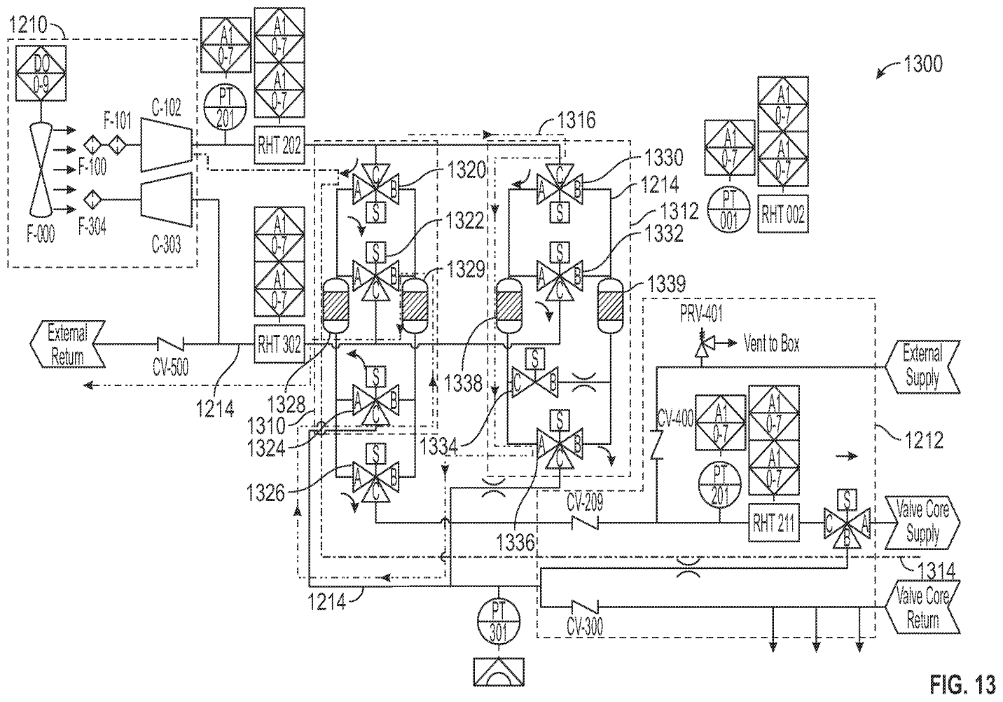

Referring now to FIG. 13, and with continued reference to FIGS. 1-12, a pneumatic diagram illustrates a pneumatic circuit 1300 for a compressor. For example, pneumatic circuit 1300 may illustrate a pneumatic flow for compressor 418. Pneumatic circuit 1300 is similar to pneumatic circuit 1200, where like numbers refer to like components. Pneumatic circuit 1300, however, includes a first desiccant portion 1310 and a second desiccant portion 1312 that create a usable airflow 1314 and a desiccant regeneration airflow 1316.

First desiccant portion 1310 includes a first valve 1320, a second valve 1322, a third valve 1324, a fourth valve 1326, a first desiccant portion 1328, and a second desiccant portion 1329. Second desiccant portion 1312 includes a first valve 1330, a second valve 1332, a third valve 1334, a fourth valve 1336, a first desiccant portion 1338, and a second desiccant portion 1339

Usable airflow 1314 continuously flows through one of first desiccant portion 1328 or second desiccant portion 1329. Desiccant regeneration airflow 1316 continuously flows through one of first desiccant portion 1338 or second desiccant portion 1339. First desiccant portion 1338 and second desiccant portion 1339 may be reduced in size relative to desiccants of pneumatic circuit 1200 and desiccant regeneration airflow 1316 may have a reduced flow.

First valve 1320 and fourth valve 1326 cooperate to direct usable airflow 1314 through one of first desiccant portion 1328 and second desiccant portion 1329 from compressor and cooler portion 1210 to valve core 424. Third valve 1324 and second valve 1322 cooperate to direct desiccant regeneration airflow 1316 through the other of first desiccant portion 1328 and second desiccant portion 1329 from second desiccant portion 1312 to the vacuum of compressor and cooler portion 1210. First valve 1330 and fourth valve 1336 cooperate to direct desiccant regeneration airflow 1316 from compressor and cooler portion 1210 to first desiccant portion 1310.

### Pneumatic Circuit and Sound Suppression Features

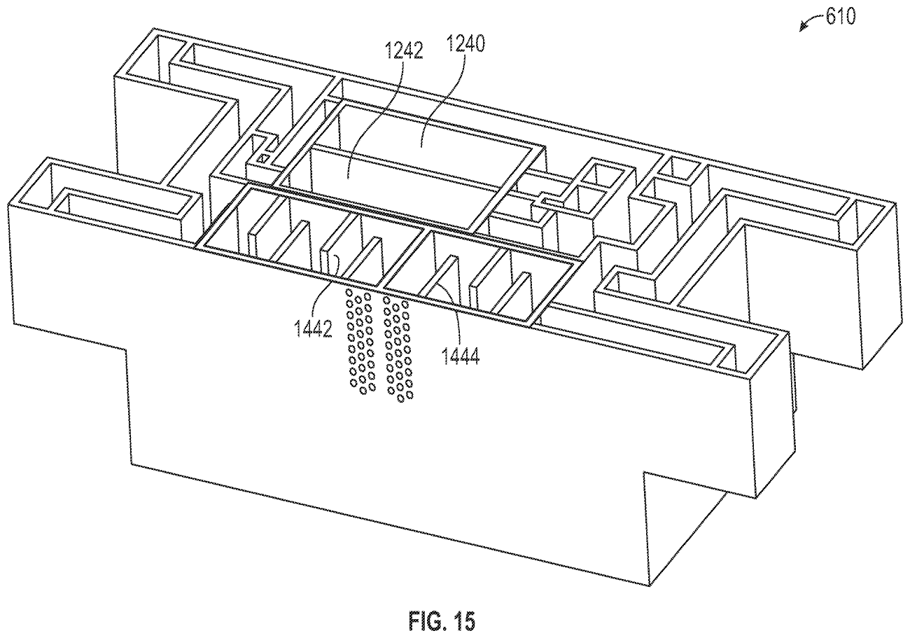

Referring now to FIGS. 14-15, a top view and a perspective view illustrate details of compressor 418 and pneumatic circuit body 610. As previously described, features of compressor 418 enable a compact, lightweight, and quiet drive system 110 that provides continuous dry air without the need to add new desiccants. As seen in FIG. 14, compressor 418 further includes supplemental pneumatic connections 1410, an input/output board 1420, and compressor gaskets 1421.

Supplemental pneumatic connections 1410 are optional connections for users that need a higher air demand than the compressor can supply. In the example provided, supplemental pneumatic connections 1410 use quick disconnect fittings for rapid connection and disconnection.

Diaphragm pumps 616 provide positive pressure and a vacuum. In the example provided, diaphragm pumps 616 are small pumps conventionally used for medical applications such as in oxygen concentrators. Diaphragm pumps 616 oppose each other in compressor 418 and are driven out of phase to cancel out vibrations. For example, the diaphragm pumps 616 may be cooperatively energized for the out of phase vibration cancelation. In some embodiments, the phase driving and orientation features may be used for about 100 times average vibration energy reduction relative to conventional compressors.

Pneumatic circuit body 610 defines pneumatic conduits to route usable airflow 1250 and desiccant regeneration airflow 1252 between the various valves and components of compressor 418. In the example provided, pneumatic circuit body 610 defines apertures 1422, a first conduit 1430, a second conduit 1432, a third conduit 1434, a fourth conduit 1436, a fifth conduit 1438, and a sixth conduit 1440.

Apertures 1422 couple the various conduits to the various valves and components of compressor 418. Second conduit 1432 includes a sound absorbing portion 1442 that includes a sound absorbing material. Sixth conduit 1440 includes a sound absorbing portion 1444 that includes a sound absorbing material. In the example provided, the conduits of pneumatic circuit body 610 are integrally formed in a plastic material of pneumatic circuit body 610 to provide pneumatic routing to air components, pressure sources, and vacuum sources. Accordingly, tubing within compressor 418 may be reduced relative to conventional compressor assemblies.

In the example provided, user input/output board 1420 includes a kill switch, a power receptacle, a USB Type-B port, a reset switch, and a WiFi connect button. The kill switch cuts power in the event top enclosure 412 separates from bottom enclosure 410. In the example provided, the kill switch is a board mounted optical flag sensor that is triggered by a rib in top enclosure 412. Input/output board 1420 may be mounted by any suitable method, including by fasteners or by heat staking. A power cable and ribbon cable connect input/output board 1420 to main control board 510.

Compressor gaskets 1421 are elastomeric and have a shape and arrangement to permit movement of diaphragm pumps 616 relative to pneumatic circuit body 610. Permitting movement restricts vibration transmission from diaphragm pumps 616 to pneumatic circuit body 610. Additional gaskets at gasketed channels 710 and connections through to strap system 422 dampen vibrations to limit vibrations felt by the user. In the example provided, each gasket at each gasketed connection is tuned in thickness, durometer, diameter, shape, and other properties based on the frequency and amplitude of vibrations measured at the gasket location in the absence of the gasket.

In some embodiments, a compressor assembly includes a housing, a first compressor, a second compressor, and an outlet portion. For example, the housing defining a first end and a second end opposing the first end may be pneumatic circuit body 610, top cover 612, and bottom cover 614. The first and second compressor may be diaphragm pumps 616. The outlet portion for providing compressed air from the compressor assembly may be compressor and cooler portion 1210.

In some embodiments, the compressor assembly includes a main body that defines a pneumatic circuit with a plurality of integral pneumatic conduits. For example, the main body may be pneumatic circuit body 610 and the internal pneumatic conduits may include first conduit 1430, second conduit 1432, third conduit 1434, fourth conduit 1436, fifth conduit 1438, and/or sixth conduit 1440.

In some embodiments, the compressor assembly further includes a plurality of valves each in pneumatic communication with at least one of the plurality of integral pneumatic conduits. For example, the plurality of valves may include first valve 1230, second valve 1232, and third valve 1234. In another example, the plurality of valves includes first valve 1320, second valve 1322, third valve 1324, fourth valve 1326, first valve 1330, second valve 1332, third valve 1334, and fourth valve 1336.

In some embodiments, the main body defines a first aperture and a second aperture in each of the plurality of integral pneumatic conduits. For example, pneumatic circuit body 610 may define apertures 1422. In some embodiments, each of the plurality of valves is in direct pneumatic communication with at least one of the first aperture and the second aperture of at least one of the plurality of integral pneumatic conduits.

In some embodiments, the plurality of integral pneumatic conduits defines a first desiccant conduit and a second desiccant conduit, where the first desiccant conduit defines a first desiccant portion between the first aperture and the second aperture of the first desiccant conduit, and wherein the second desiccant conduit defines a second desiccant portion between the first aperture and the second aperture of the second desiccant portion. For example, pneumatic circuit body 610 may define first desiccant portion 1240 and second desiccant portion 1242.

In some embodiments, the plurality of integral pneumatic conduits define at least one sound absorbing portion configured to muffle sound traveling through the pneumatic circuit. For example, pneumatic circuit body 610 may define sound absorbing portion 1442 and/or sound absorbing portion 1444. In some embodiments, a sound absorbing material is disposed in the at least one sound absorbing portion.

In some embodiments, the compressor assembly further includes a first desiccant portion, a second desiccant portion, and a plurality of valves configured to direct a first airflow and a second airflow. For example, the first desiccant portion may be first desiccant portion 1240 or first desiccant portion 1328. The second desiccant portion may be, for example, second desiccant portion 1242 or second desiccant portion 1329.

In some embodiments, the plurality of valves has a first configuration and a second configuration. The first configuration directs the first airflow from the first compressor and the second compressor through the first desiccant portion to the outlet. The first configuration further directs the second airflow from the first airflow through the second desiccant portion for desiccant drying in the second desiccant portion. For example, the first configuration may be the valve positions illustrated in FIG. 12 or in FIG. 13 resulting in the illustrated usable airflow 1250, desiccant regeneration airflow 1252, usable airflow 1314, and desiccant regeneration airflow 1316.

In some embodiments, the second configuration directs the first airflow from the first compressor and the second compressor through the second desiccant portion to the outlet. The second configuration further directs the second airflow from the first airflow through the first desiccant portion for desiccant drying in the first desiccant portion. For example, the second configuration may be where first valve 1230 directs usable airflow 1250 through second desiccant portion 1242 or where first valve 1320 directs usable airflow 1314 through second desiccant portion 1329. In some embodiments, first desiccant portion 1338 is a third desiccant portion and second desiccant portion 1339 is a fourth desiccant portion.

In some embodiments, the second airflow begins at a portion of the first airflow. For example, the first configuration may direct desiccant regeneration airflow 1252 beginning at third valve 1234 in pneumatic communication with usable airflow 1250. In some embodiments, the first and the second configuration may direct the second airflow beginning at the first airflow before the first airflow passes through either of the first desiccant portion or the second desiccant portion. For example, first valve 1330 may direct desiccant regeneration airflow 1316 branching from usable airflow 1314 between compressor and cooler portion 1210 and first valve 1320.

### Testing and Assembly Processes for the Drive System

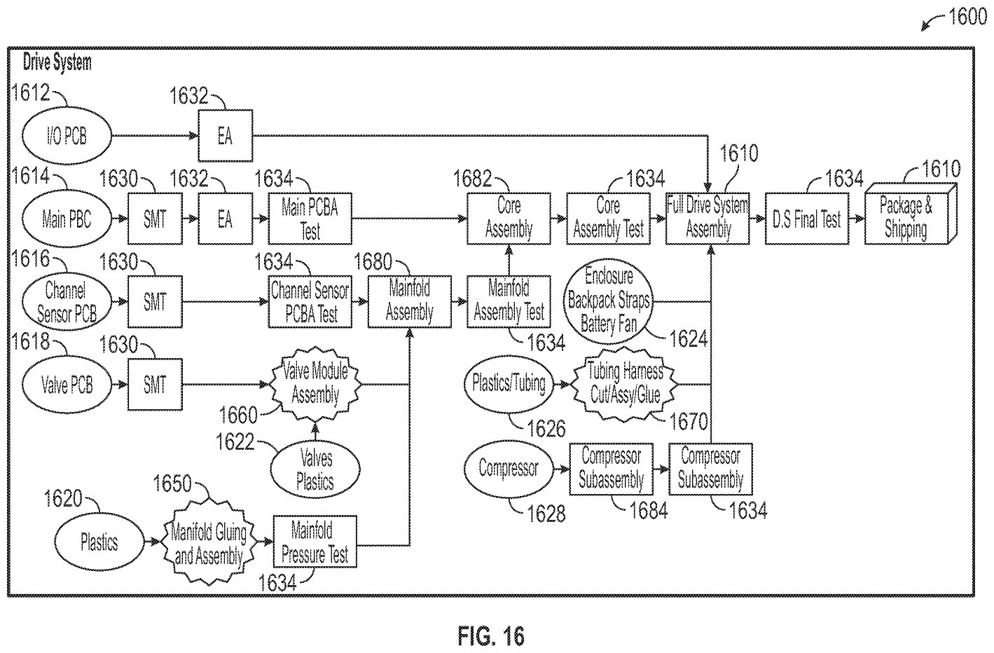

Referring now to FIG. 16, a process diagram illustrates testing and assembly processes 1600 for the drive system 110 in accordance with the teaching of the present disclosure.

Testing and assembly processes 1600 describe assembly of a full drive system 1610 from an input/output PCB 1612, a main PCB 1614, a channel sensor PCB 1616, a valve PCB 1618, plastic components 1620, valves for plastics 1622, drive system miscellaneous parts 1624, plastics and tubing 1626, and compressor pneumatic circuit 1628.

The processes include SMT electrical processes 1630, EA electrical processes 1632, and suitability tests 1634. The processes further include a manifold gluing and assembly process 1650, a valve module assembly process 1660, and a tubing harness cut/assembly/glue process 1670.

Manifold gluing and assembly process 1650 includes: placing three top manifolds in a holding device, use gluing robot to apply cyanoacrylate glue or similar to the top manifolds, place middle manifold on top manifolds, use gluing robot to apply Cyanoacrylate glue or similar to the middle manifold, place the bottom manifold on the middle manifold, clamp parts together, and pressure test. Clamping continues until curing is complete.

Valve module assembly process 1660 includes: placing two pressure sensor gaskets on each channel sensor board, securing three channel sensor boards to the manifold plastic assembly using screws, and installing three valve boards to the manifold plastic assembly using snap arms.

Tubing harness cut/assembly/glue process 1670 is described below with reference to FIG. 22.

Through the testing and assembly processes 1600, intermediate assemblies for a manifold assembly 1680, a core assembly 1682, and a compressor assembly 1684 are created.

Assembly of full drive system 1610 includes a first task to slip backpack strap buckles through slots in the bottom enclosure and flatten the buckles against the ribs in the bottom enclosure. A second task is to place the valve core and compressor assembly into the bottom enclosure. A third task is to secure multi-channel pneumatic connectors in the bottom enclosure. A fourth task is to insert the cooling fan into the bottom enclosure and connect wires to the main board. A fifth task is to insert the input/output board into the bottom enclosure and use screws or heat staking to secure the input/output board. A sixth task is to insert the power switch into the bottom enclosure and connect the cable harness. A seventh task is to connect wires to the switch and input/output board. An eighth task is to insert quick connect pneumatic fittings into the bottom enclosure. A ninth task is to connect tubing to the compressor housing. A tenth task is to attach a peripheral data cable harness to the bottom enclosure and to the Main Board. An eleventh task is to place the top enclosure on the bottom enclosure and fasten with screws. A twelfth task is to insert the battery. A thirteenth task is to test full drive system 1610.

### Glove Peripherals

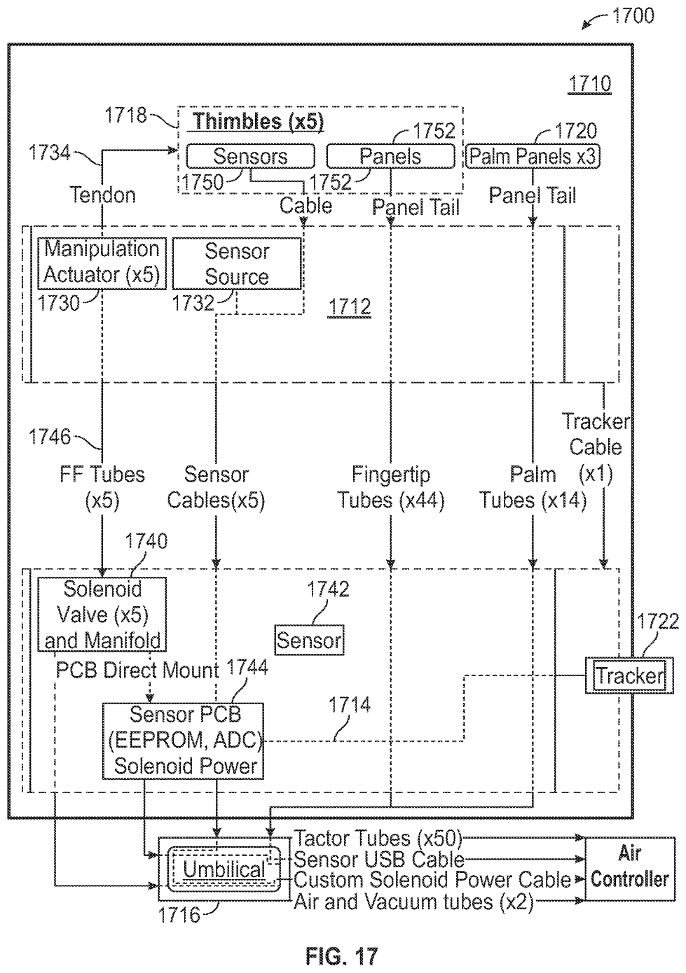

Referring now to FIG. 17, and with continued reference to FIGS. 1-16, electronics of a glove assembly 1700 are illustrated in a simplified block diagram in accordance with the teachings of the present disclosure. Glove assembly 1700 is a haptic feedback glove that includes an interface laminate with a plurality of tactile actuators coupled to the skin of the user's hand. Glove assembly 1700 includes an opisthenar assembly 1712, a wrist assembly 1714, an umbilical assembly 1716, thimble assemblies 1718, palm panels 1720, and a tracker 1722.

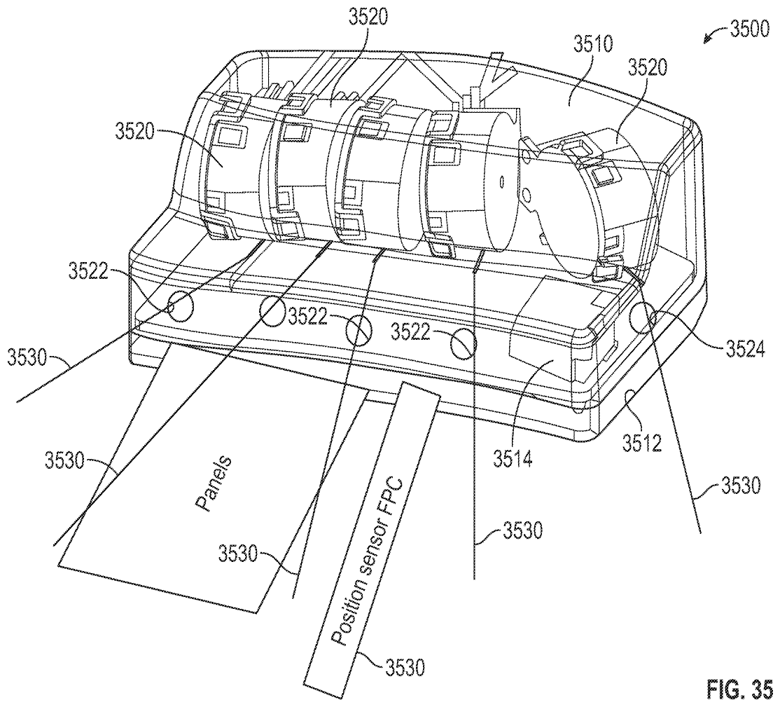

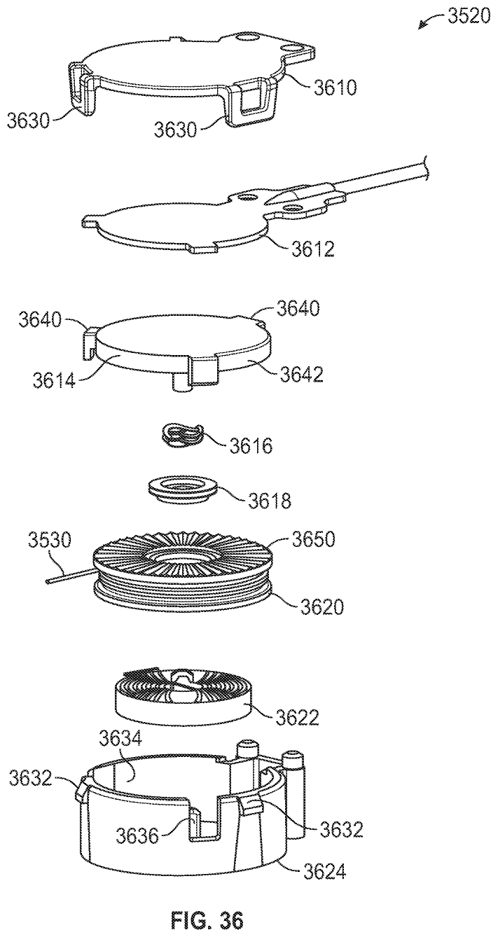

Opisthenar assembly 1712 is disposed on the back of glove assembly 1700 corresponding to the dorsal side of the user's hand. Opisthenar assembly 1712 includes manipulation actuators 1730 and a magnetic emitter 1732. Manipulation actuators 1730 control tendons 1734 that each provides force feedback to a finger of the user's hand, as will be explained below with reference to FIGS. 35-36. Magnetic emitter 1732 may be an example of magnetic emitter 230.

Wrist assembly 1714 is disposed on a back of the glove corresponding to the back of the user's wrist. Wrist assembly 1714 includes solenoid valves 1740, a position sensor 1742, and a sensor PCB 1744. Solenoid valve 1740 selectively permits compressed air to enter force feedback tubes 1746 for actuation of manipulation actuators 1730. Position sensor 1742 may be an example of position sensors 232. Sensor PCB 1744 receives signals from position sensors 1750 and position sensor 1742 to calculate the relative position to sensor source 1732. In some embodiments, wrist assembly 1714 includes fewer components. For example, solenoid valve 1740 may be omitted in wrist assembly 1714 in favor of valve control from the drive unit.

Umbilical assembly 1716 connects drive system 110 to gloves 112. In the example provided, umbilical assembly 1716 includes 59 pneumatic tubes for actuators in glove assembly 1700, a sensor USB cable, a solenoid power cable, and two air and vacuum tubes for air supply to solenoid valve manifold 1740.

Thimble assemblies 1718 provide tactile feedback to the user, provide counterpressure for the tactile feedback, provide a kinematic termination for tendons 1734, and define the location of position sensors for finger portions of glove assembly 1700. In the example provided, thimble assemblies 1718 include position sensors 1750 and tactile panels 1752.

Palm panels 1720 includes tactors for tactile feedback to a palm of the user, as is discussed below with reference to FIG. 41. Tracker 1722 may be an example of motion tracker 238.

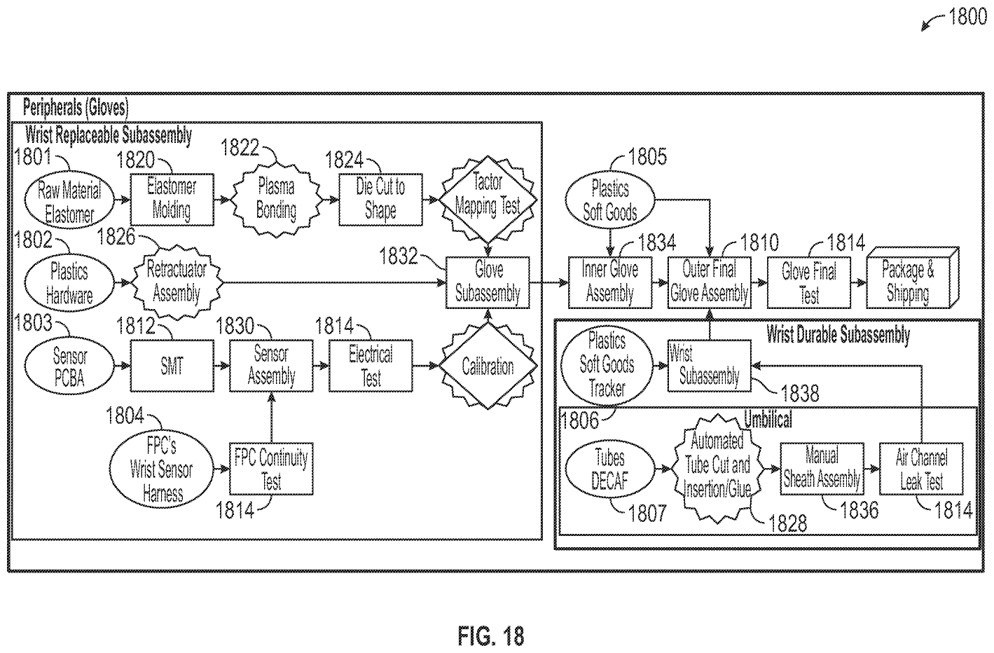

Referring now to FIG. 18, and with continued reference to FIGS. 1-17, a process diagram illustrates testing and assembly processes 1800 for a glove assembly 1810 in accordance with the teaching of the present disclosure. For example, testing and assembly processes 1800 may be used for glove assembly 1700 or gloves 112.

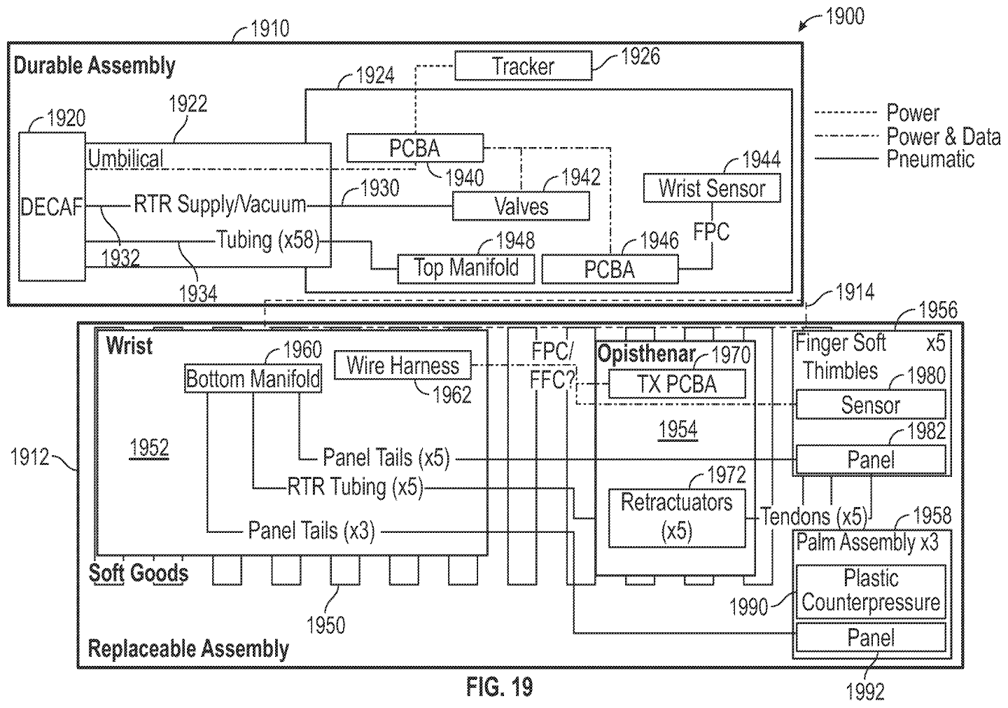

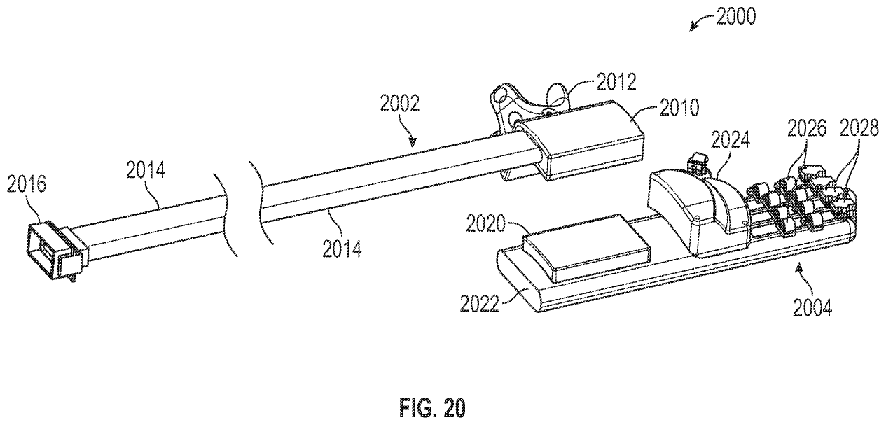

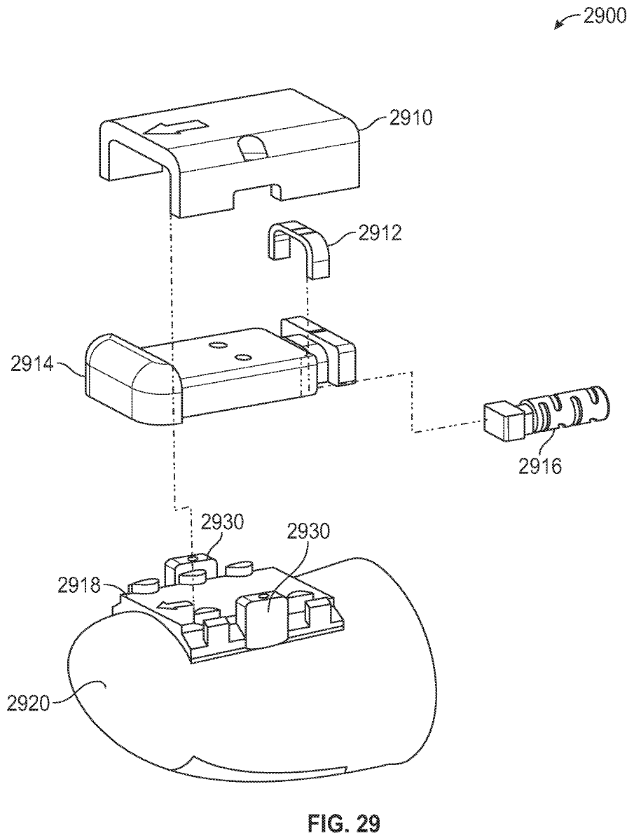

Testing and assembly processes 1800 result in glove assembly 1810 with inputs of an elastomeric material 1801, plastics and hardware 1802, a position sensor PCBA 1803, FPC 1804 for wrist sensor and position sensor harness, plastics and soft goods 1805, plastics and soft goods and tracker 1806, and tubes and multi-channel pneumatic connector 1807. In the example provided, elastomeric material 1801 is a sheet fomed from a raw material elastomer, such as a high consistence rubber material, and may also be known as gum stock silicone. Plastics and hardware 1802 include components described with reference to FIG. 36 below. Position sensor PCBA 1803 may be an example of sensor PCB 1744. FPCs 1804 may include various electronic components illustrated in FIG. 19. Plastics and soft goods 1805 may include various components from FIGS. 29-32 described below. Plastics and soft goods and tracker 1806 may include various components from FIG. 20 described below. Tubes and multi-channel pneumatic connector 1807 may include various components shown and described in FIG. 48 below. The inputs may, for example, be assembled or manufactured by the assembling entity in other processes in the same manufacturing facility or by other entities, such as by suppliers.

Testing and assembly processes 1800 include an SMT electrical process 1812, suitability test processes 1814, an elastomer molding process 1820, a plasma bonding process 1822, a die cut to shape process 1824, a manipulation actuator assembly process 1826, and an automated tube cut and insertion/glue process 1828.

Through testing and assembly processes 1800, intermediate assemblies for a position sensor assembly 1830, a replaceable glove subassembly 1832, an inner glove assembly 1834, a manual sheath assembly 1836, and a wrist durable subassembly 1838 are created, as will become apparent with reference to the FIGS. below.

### Replaceable-Durable Assembly

Referring now to FIG. 19, and with continued reference to FIGS. 1-18, a simplified block diagram illustrates a replaceable-durable assembly 1900. Replaceable-durable assembly 1900 includes a durable subassembly 1910 and a replaceable subassembly 1912. Durable subassembly 1910 and replaceable subassembly 1912 each include components on an interface 1914. The physical locations of durable subassembly 1910 and replaceable subassembly 1912 may vary and span several assemblies described elsewhere based on physical location. In the example provided, wrist assembly 1714 spans durable subassembly 1910 and replaceable subassembly 1912.

Durable subassembly 1910 has items with longer service lives than at least some of those of replaceable subassembly 1912. Durable subassembly 1910 includes a multi-channel pneumatic connector 1920, an umbilical 1922, a durable wrist subassembly 1924, and a tracker 1926.

Umbilical 1922 includes a power and data cable 1930, manipulation actuator pneumatic tubing 1932, and tactor tubing 1934. In the example provided, umbilical 1922 includes a protective sheath to limit damage to power and data cable 1930, manipulation actuator pneumatic tubing 1932, and tactor tubing 1934.

Multi-channel pneumatic connector 1920 is a connector for power and data cable 1930, manipulation actuator pneumatic tubing 1932, and tactor tubing 1934 to connect to a drive system, such as drive system 110. Multi-channel pneumatic connector 1920 may be an example of the multi-channel pneumatic connector described with reference to FIG. 22 below.

Durable wrist subassembly 1924 includes wrist PCBA 1940, miniature pneumatic valves 1942, wrist position sensor 1944, position sensor PCBA 1946, and top manifold 1948. Wrist PCBA 1940 includes electronics to control miniature pneumatic valves 1942, interact with tracker 1926, and to interact with position sensor PCBA 1946. Position sensor PCBA 1946 includes electronics to interact with wrist position sensor 1944.

Miniature pneumatic valves 1942 may be VOVK valves commercially available from FESTO. Tracker 1926 may be an example of motion tracker 238.

Replaceable subassembly 1912 includes gloves 1950, replaceable wrist subassembly 1952, opisthenar subassembly 1954, finger thimbles 1956, and palm assembly 1958.

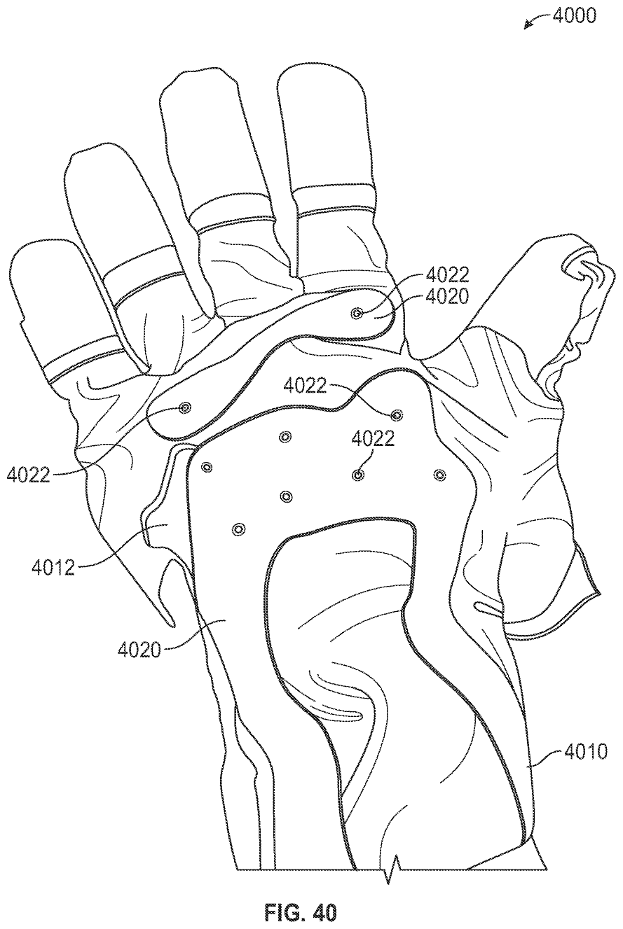

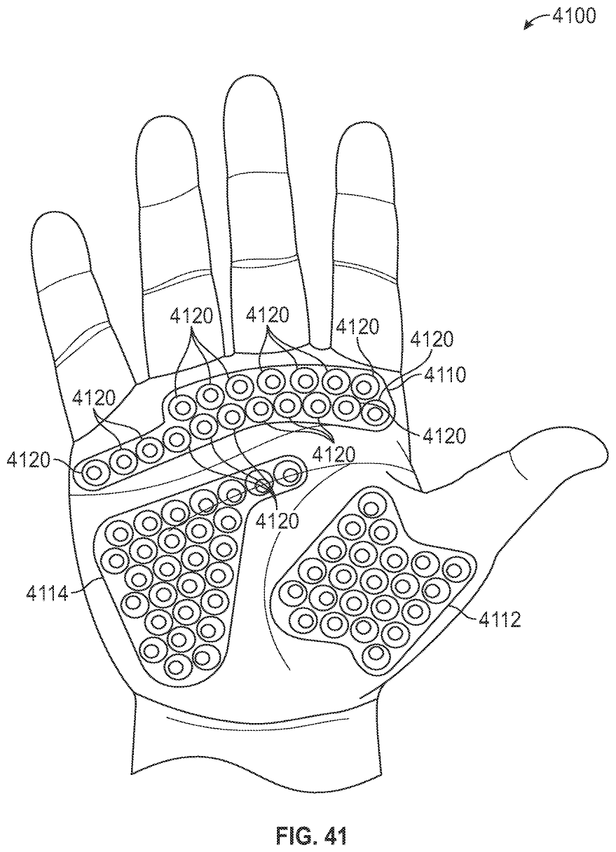

Gloves 1950 may include an inner glove and an outer glove, as described below with reference to FIGS. 40-46. Gloves 1950 may come in various sizes to support different sized hands of users. Gloves 1950 are generally less durable than other components of replaceable-durable assembly 1900 due to wear from use.

Replaceable wrist subassembly 1952 includes a bottom manifold 1960 and a position sensor wire harness 1962. Opisthenar subassembly 1954 includes a magnetic emitter PCBA 1970 and manipulation actuators 1972. Magnetic emitter PCBA 1970 may be an example of magnetic emitter 230. Manipulation actuators 1972 may be an example of manipulation actuators 1730.

Finger thimbles 1956 each include a position sensor 1980 and a panel 1982. Position sensor 1980 may be an example of position sensors 232 that track a position of each finger. Panel 1982 may be an example of tactile panels 1752 that provide tactile feedback.

Palm assembly 1958 includes a plastic counterpressure portion 1990 and a panel 1992. Plastic counterpressure portion 1990 supports counterpressure grounded at opisthenar subassembly 1954 as shown below in FIGS. 38-41. Panel 1992 may be an example of palm panel 1720.

In the example provided, interface 1914 is defined in part by connections between top manifold 1948 and bottom manifold 1960. In the example provided, interface 1914 is further defined in part by connections between position sensor PCBA 1946 and position sensor wire harness 1962. The electrical connections may be any suitable connections for power and data. In the example provided, the connection between top manifold 1948 and bottom manifold 1960 utilizes face seals, as discussed below with reference to FIGS. 22-24.

In some embodiments, replaceable subassembly 1912 includes only gloves 1950, finger panels 1982, and palm panel 1992 with the other components of replaceable-durable assembly 1900 disposed in durable subassembly 1910. For example, durable subassembly 1910 may include finger thimbles 1956 without panel 1982 and palms 1958 without panel 1992. In such embodiments, interface 1914 includes pneumatic connections at each of panels 1982 and panel 1992 for actuation of the respective panel 1982 or panel 1992. For example, the pneumatic connections may be similar to the face seals discussed below with reference to FIGS. 22-24.

In some embodiments, replaceable subassembly 1912 includes gloves 1950, finger thimbles 1956, and palms 1958 with the other components of replaceable-durable assembly 1900 disposed in durable subassembly 1910.

In some embodiments, replaceable subassembly 1912 includes gloves 1950, finger thimbles 1956, palm assembly 1958, and sensor signal electronics with the other components of replaceable-durable assembly 1900 disposed in durable subassembly 1910. For example, the sensor signal electronics may include analog to digital conversion electronics to limit the travel and degradation of analog sensor signals. In some embodiments, the sensor signal electronics are integrated with position sensors 1980.

In some embodiments, durable subassembly 1910 includes a top housing that is coupled to a bottom housing of replaceable subassembly 1912 using clips or screws.

Referring now to FIG. 20, and with continued reference to FIGS. 1-19, a perspective view illustrates an example of a replaceable-durable assembly 2000. In the example provided, reusable assembly 2000 is an implementation of replaceable-durable assembly 1900.

Peripheral assembly 2000 includes a durable subassembly 2002 and a replaceable subassembly 2004.

Durable subassembly 2002 includes a wrist reusable assembly 2010, a tracker 2012, an umbilical 2014, and a glove connector 2016. Wrist reusable assembly 2010 may be an example of durable wrist subassembly 1924. Tracker 2012 may be an example of motion tracker 238. Umbilical 2014 may be an example of umbilical 1922. Glove connector 2016 may have electronic connections and pneumatic connections as described below with reference to FIG. 22.

Replaceable subassembly 2004 includes a wrist replaceable subassembly 2020, soft goods 2022, an opisthenar assembly 2024, tendon guides 2026, and thimble assemblies 2028. Wrist replaceable subassembly 2020 may be an example of replaceable wrist subassembly 1952.

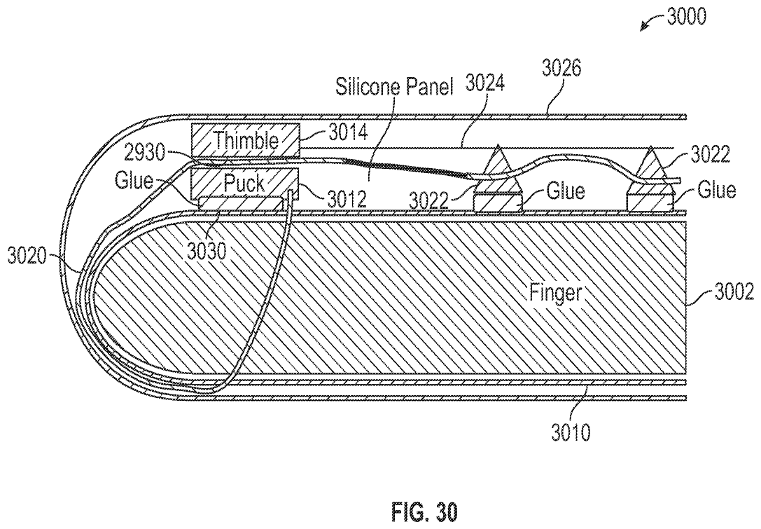

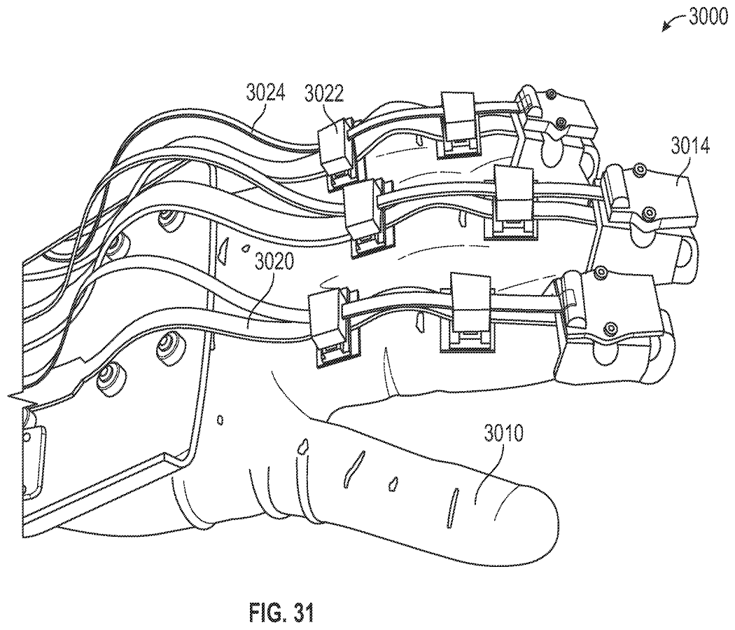

Soft goods 2022 may include gloves, fabrics, flexible rubbers, and other materials and components consistent with the “soft goods” engineering term of art. Opisthenar assembly 2024 may be an example of opisthenar subassembly 1954. Tendon guides 2026 provide guides for force feedback tendons, as will become apparent with reference to FIGS. 30-32 discussed below.

Thimble assemblies 2028 may be examples of finger thimbles 1956 for providing tactile feedback and terminating force feedback to a user's fingers, as will become apparent with reference to FIGS. 29-30, as discussed below.

By including opisthenar assembly 2024 and wrist replaceable subassembly 2020 separated by soft goods 2022, wrist mobility is retained for the user.

### Multi-Channel Pneumatic Connector

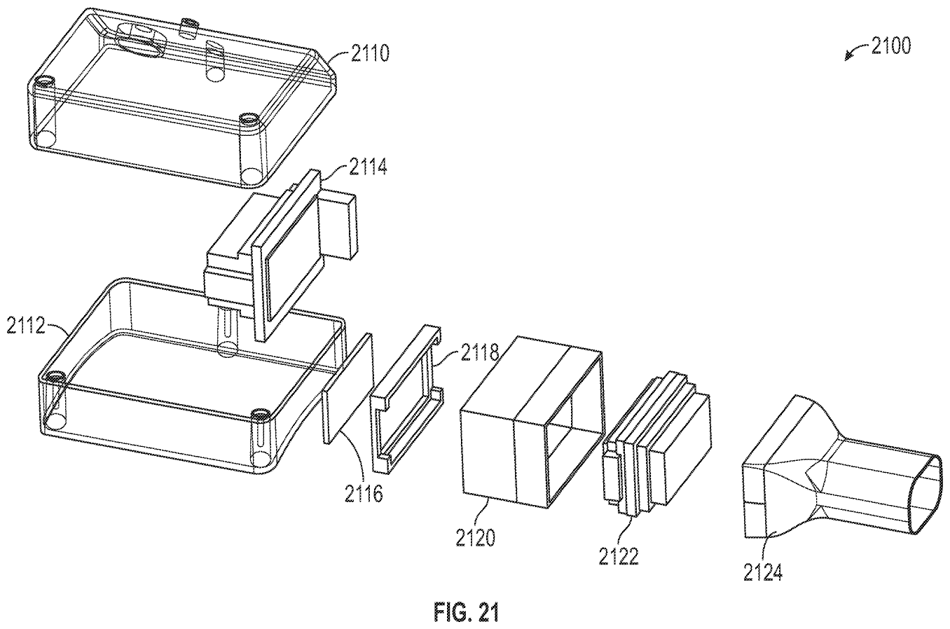

Referring now to FIG. 21, and with continued reference to FIGS. 1-20, an exploded view illustrates a multi-channel pneumatic connector 2100. Multi-channel pneumatic connector 2100 is a compact assembly for connecting a large and dense assembly of tubing to other pneumatic conduits. In the example provided, multi-channel pneumatic connector 2100 connects tubes from drive system 110 to wrist assembly 1714. In the example provided, multi-channel pneumatic connector 2100 is a straight plug connector. In some embodiments, multi-channel pneumatic connector 2100 is a threaded twist connector.

Multi-channel pneumatic connector 2100 includes a wrist top shell 2110, a wrist bottom shell 2112, a console insert 2114, a gasket 2116, a face plate 2118, a shell 2120, an umbilical insert 2122, and an umbilical sheath 2124.

Wrist top shell 2110 and a wrist bottom shell 2112 couple together to form a housing. Gasket 2116 seals against console insert 2114 and umbilical insert 2122 to restrict air leakage.

Sheath 2124 holds tubing and cables and is captured between shell 2120 and umbilical insert 2122. Shell 2120 and face plate 2118 snap together with umbilical insert 2122.

In the example provided, multi-channel pneumatic connector 2100 is injection molded and couples umbilical insert 2122 and umbilical insert 2122 using clips.

Referring now to FIGS. 22-24, and with continued reference to FIGS. 1-21, a multi-channel pneumatic connector 2200 is illustrated in a cutaway view in accordance with the teachings of the present disclosure. In the example provided, multi-channel pneumatic connector 2200 connects tubing to tactile panels.

Multi-channel pneumatic connector 2200 includes tubing 2210, tubing connector 2212, and pneumatic component 2214. In the example provided, pneumatic component 2214 is a tactile panel. It should be appreciated that multi-channel pneumatic connector 2200 may be used at any tubing termination point without departing from the scope of the present disclosure.

Tubing connector 2212 defines air channels 2220, tubing receiving portions 2222, glue receiving portions 2224, and face seal apertures 2226. Air channel 2220 couples tubing 2210 to the respective face seal aperture 2226 for fluid communication.

In the example provided, tubing receiving portion 2222 is substantially cylindrical with a tubing stop face 2227 against which tubing 2210 may be pressed during assembly. In the example provided, glue receiving portion 2224 is substantially conically shaped with a reducing diameter as glue receiving portion 2224 extends into tubing connector 2212.

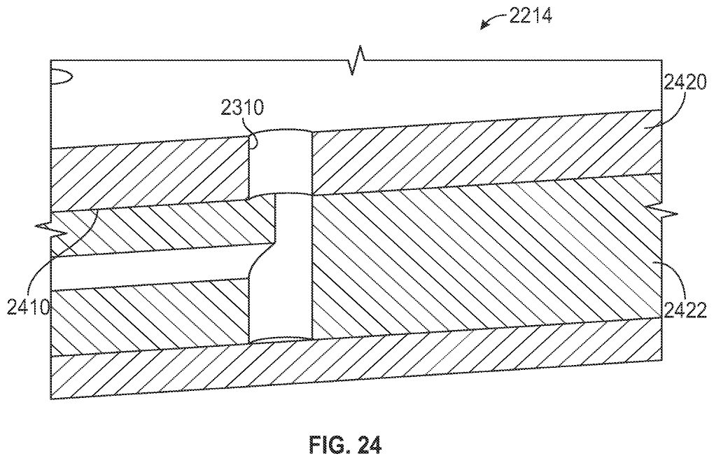

Pneumatic component 2214 defines face seal apertures 2310 and air channels 2410, as can best be seen in FIG. 22 and FIG. 24, respectively. In the example provided, air channels 2410 are each in fluid communication with at least one tactor in a tactile panel.

In the example provided, pneumatic component 2214 is formed from a channel side silicone layer 2420 plasma bonded onto a molded elastomer layer 2422. Face seal apertures 2310 are cut into pneumatic component 2214 to make a connection between the upper surface of channel side silicone layer 2420 and air channels 2410 of molded elastomer layer 2422.

### Tactile Panels

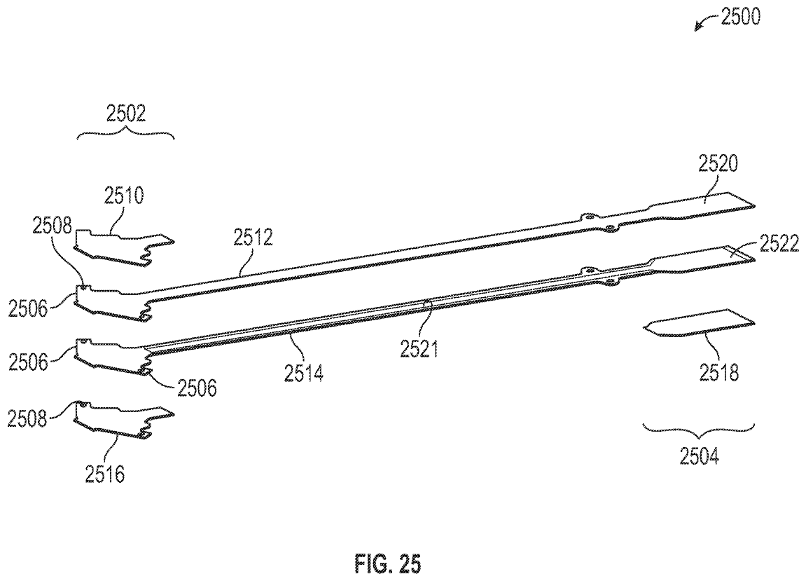

Referring now to FIG. 25, and with continued reference to FIGS. 1-24, a tactile panel assembly 2500 is illustrated in an exploded view in accordance with some embodiments. Tactile panel assembly 2500 includes a reinforced sheeting layer 2510, a channel side silicone layer 2512, a molded elastomer layer 2514, a tactor side silicone layer 2516, and a panel tail silicone layer 2518. Tactile panel assembly 2500 defines a tactor side 2502 and a connector side 2504. Tactor side 2502 defines wings or tabs 2506 with through-holes 2508. In the example provided, tabs 2506 wrap around a finger of a user and through-holes 2508 accommodate securement of tactile panel assembly 2500 to a fingertip assembly of the glove assembly, as will be described below with reference to FIG. 30.

Reinforced sheeting layer 2510 provides backpressure to support flexibility in thimble assemblies. Reinforced sheeting layer 2510 is plasma bonded to channel side silicone layer 2512. In the example provided, reinforced sheeting layer 2510 is formed from a fabric reinforced silicone. Reinforced sheeting layer 2510 has a shape that cooperates with fingertip assembly plastics to provide counter pressure tasks for grounding forces from the tactors and from the force feedback tendon pulling on the user's finger. The fabric reinforced silicone is strong enough for these counterpressure tasks and grounding forces while still permitting tactile panel assembly 2500 to be flexible enough for stretching to accommodate fingertip size variations while still providing sufficient counter pressure for good tactile sensations. The fabric reinforced silicone is further flexible enough for improved realistic interaction with physical props when compared with rigid plastic fingertips.

Channel side silicone layer 2512, tactor side silicone layer 2516, and panel tail silicone layer 2518 are each plasma bonded to molded elastomer layer 2514. Channel side silicone layer 2512 defines a termination portion 2520 through which face seal apertures are cut. For example, face seal apertures 2310 may be cut into channel side silicone layer 2512.

Molded elastomer layer 2514 defines a plurality of channels 2521 and a termination portion 2522 through which face seal apertures are cut. For example, face seal apertures 2310 may be cut through channel side silicone layer 2512 into molded elastomer layer 2514 at termination portion 2522 to channels 2521.

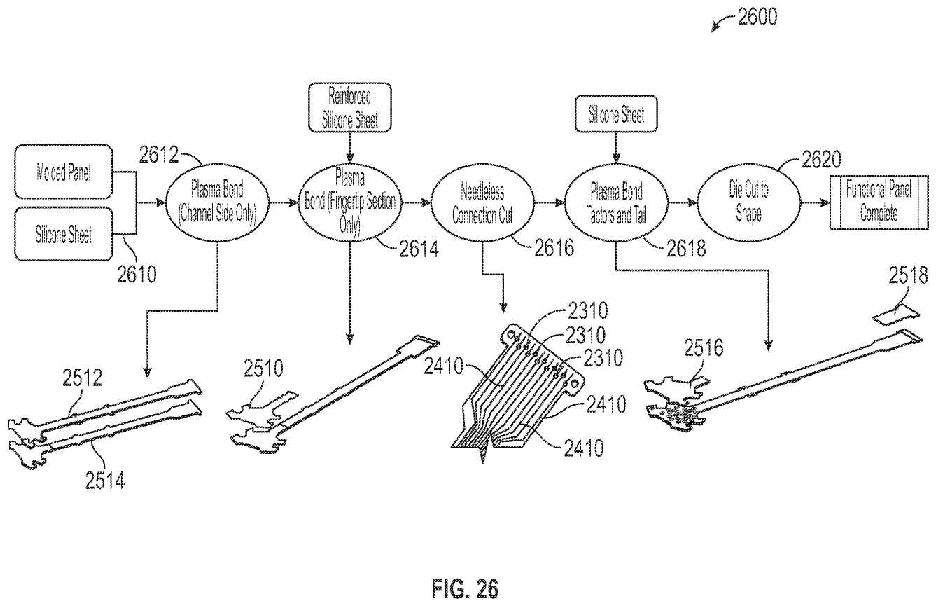

Referring now to FIG. 26, and with continued reference to FIGS. 1-25, a finger panel fabrication process 2600 is illustrated in a flow diagram view. Finger panel fabrication process 2600 may be used, for example, to fabricate tactile panel assembly 2500.

Finger panel fabrication process 2600 includes providing layers 2610, a first plasma bonding task 2612, a second plasma bonding task 2614, a needleless connection cut task 2616, a third plasma bonding task 2618, and a cut to shape task 2620.

In the example provided, providing layers 2610 includes providing channel side silicone layer 2512 and molded elastomer layer 2514.

First plasma bonding task 2612 includes plasma bonding the layers provided in providing layers 2610 task. In the example provided, first plasma bonding task 2612 includes plasma bonding channel side silicone layer 2512 to molded elastomer layer 2514. As is appreciated by those of ordinary skill in the art, plasma bonding is a method of forming a direct chemical connection between the two layers of silicone.

Second plasma bonding task 2614 includes plasma bonding a reinforcement layer onto the assembly produced by first plasma bonding task 2612. In the example provided, reinforced sheeting layer 2510 is plasma bonded onto the already bonded channel side silicone layer 2512 and molded elastomer layer 2514 assembly. In the example provided, second plasma bonding task 2614 further includes an oven heating process after lamination of reinforced sheeting layer 2510 to the assembly.

Needleless connection cut task 2616 punches the needleless connection holes in the panel. For example, needleless connection cut task 2616 may punch face seal apertures 2310 through channel side silicone layer 2512 and at least partially through molded elastomer layer 2514 to air channels 2410.

Third plasma bonding task 2618 includes bonding additional silicone layers to a tactor side and a panel tail side of the assembly. In the example provided, third plasma bonding task 2618 bonds tactor side silicone layer 2516 and panel tail silicone layer 2518 to the bonded and cut assembly of channel side silicone layer 2512 and molded elastomer layer 2514. In the example provided, third plasma bonding task 2618 further includes an oven heating process after lamination of needleless connection cut task 2616 and panel tail silicone layer 2518 to the assembly.

Cut to shape task 2620 includes die cutting the assembly to the final shape.

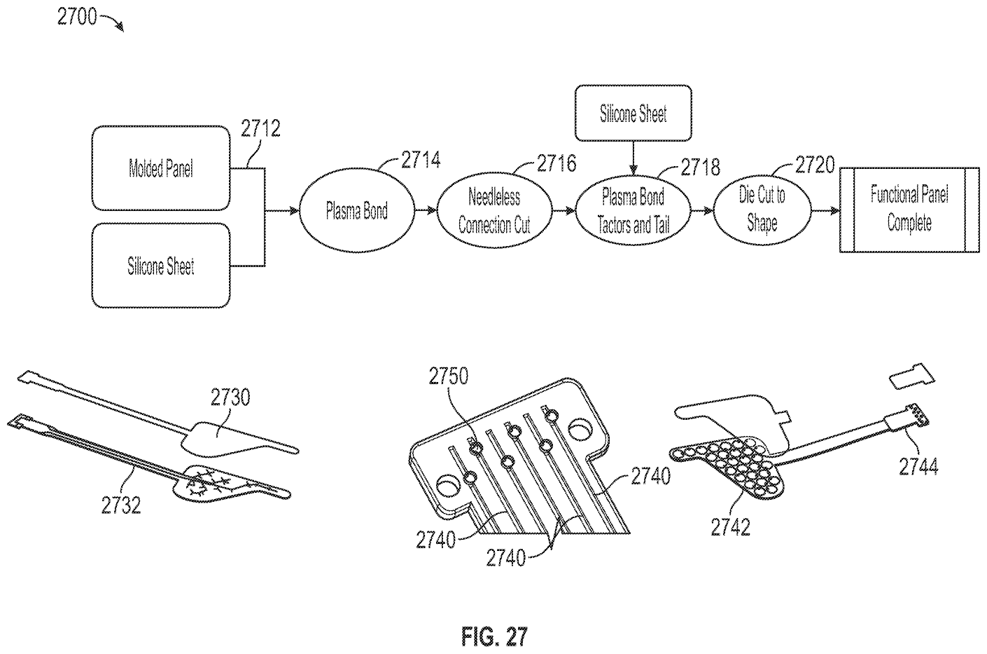

Referring now to FIG. 27, and with continued reference to FIGS. 1-26, a palm panel fabrication process 2700 is illustrated in a flow diagram view. Palm panel fabrication process 2700 may be used, for example, to fabricate palm panel 1720.

Palm panel fabrication process 2700 includes providing layers 2712, a first plasma bonding task 2714, a needleless connection cut task 2716, a second plasma bonding task 2718, and a die cutting task 2720.

Providing layers 2712 task includes providing a sheeting layer 2730 and a molded elastomer layer 2732. In the example provided, channel side silicone layer 2730 is similar to channel side silicone layer 2512 and molded elastomer layer 2732 is similar to molded elastomer layer 2514. Channel side silicone layer 2730 and molded elastomer layer 2732, however, have shapes suited to use with palm panel 1720. In the example provided, the left and right gloves use palm panels with mirrored shapes to fit the left and right hands. Molded elastomer layer 2732 defines air channels 2740, tactor portion 2742, and tail connection portion 2744. The number of air channels 2740 and tactors in tactor portion 2742 is based on the desired haptic feedback to a palm of the user.

First plasma bonding task 2714 includes plasma bonding channel side silicone layer 2730 to molded elastomer layer 2732. In an intermediate task (not illustrated), a reinforced sheet similar to reinforced sheeting layer 2510 may be plasma bonded to the bonded assembly of channel side silicone layer 2730 and molded elastomer layer 2732.

Needleless connection cut task 2716 includes punching needleless connection holes 2750 in the assembly of bonded channel side silicone layer 2730 and molded elastomer layer 2732. Needleless connection holes 2750 are similar to face seal apertures 2310 and define a conduit through which a multi-channel pneumatic connector may make a face seal connection to air channels 2740.

Die cutting task 2720 cuts the bonded and cut assembly to a final shape for use in a glove assembly.

Referring now to FIG. 28, and with continued reference to FIGS. 1-27, tactile panel testing images 2800 are illustrated in a simplified diagram in accordance with the teachings of the present disclosure.

Tactile panel testing images 2800 illustrate a testing process using machine vision to confirm tactor operability and channel mapping. In the example provided, a machine vision system is coupled with a pneumatic valve to inflate each tactor and confirm that each tactor inflates in response to actuation of the respective pneumatic valve. In the example provided, an inflated tactor 2810 is illustrated among a plurality of uninflated tactors 2820.

Accordingly, the vision system may be used to confirm the inflation properties of each tactile panel after fabrication. In the example provided, tactile panels are tested using tactile panel testing images 2800 after fabrication and before being secured to an inner glove of a glove assembly.

### Finger Assembly

Referring now to FIG. 29, and with continued reference to FIGS. 1-28, a fingertip assembly 2900 is illustrated in an exploded view in accordance with the teachings of the present disclosure.

Fingertip assembly 2900 includes a thimble 2910, a tendon clip 2912, a position sensor shell 2914, a cable strain relief 2916, a puck 2918, and a finger portion 2920 of inner glove 3010.

Thimble 2910 is a rigid plastic part that secures tendon clip 2912, position sensor shell 2914, and cable strain relief 2916 to puck 2918. Tendon clip 2912 secures a tendon (illustrated as 3024 in FIG. 30) to fingertip assembly 2900. Position sensor shell 2914 houses finger position sensors. Cable strain relief 2916 provides cable protection for sensor wires for the finger position sensors in position sensor shell 2914.

Puck 2918 is secured to finger portion 2920 over a fingernail portion of the user's expected finger position to ground tactor counterpressure at the user's fingernail. Puck 2918 defines projections 2930 extending away from finger portion 2920 to accommodate a tactile panel assembly, as described below with reference to FIG. 30. For example, puck 2918 may be heat stake riveted or glued to a fabric of inner glove 3010.

Referring now to FIGS. 30-31, and with continued reference to FIGS. 1-29, a glove assembly 3000 is illustrated in a simplified cutaway side view in accordance with the teachings of the present disclosure.

Glove assembly 3000 is illustrated on a user's finger 3002 and includes an inner glove 3010, a puck 3012, a thimble 3014, a silicone panel 3020, tendon guides 3022, tendons 3024, and an outer glove 3026 (not shown in FIG. 31).

Inner glove 3010 is a flexible glove that serves as an interface layer between the glove assembly and the user's skin. Inner glove 3010 may be made from LYCRA or another lightweight, elastic fabric.

Puck 3012 is an example of puck 2918 and is secured to inner glove 3010 with glue 3030 above an expected location of a user's fingernail. In some embodiments, puck 3012 is riveted to inner glove 3010.

Puck 3012 grounds reaction forces from actuator of tactors at the fingertip of silicone panel 3020. For example, as tactors actuate and press against finger 3002, tensile forces in silicone panel 3020 hold the tactors against finger 3002. The tensile forces in silicone panel 3020 pull against projections 2930 and also present on puck 3012 to create compressive forces against glue 3030 and the fingernail of finger 3002. Because puck 3012 and the fingernail are substantially rigid, the compressive forces are distributed across the surface area of the fingernail to limit tactile sensations from the counterpressure for the user.

Thimble 3014 is an example of thimble 2910 and is secured against puck 3012 to clamp silicone panel 3020 and tendons 3024.

Silicone panel 3020 is an example of tactile panel assembly 2500. Silicone panel 3020 is routed and curved around finger 3002 to puck 3012. In the example provided, projections 2930 are also present on puck 3012 to hold silicone panel 3020 in place on puck 3012. Silicone panel 3020 extends along finger and through tendon guides 3022 and ultimately to a multi-channel pneumatic connector. In the example provided, silicone panel 3020 includes 24 tactile actuators capable of producing a displacement of at least 1 mm.

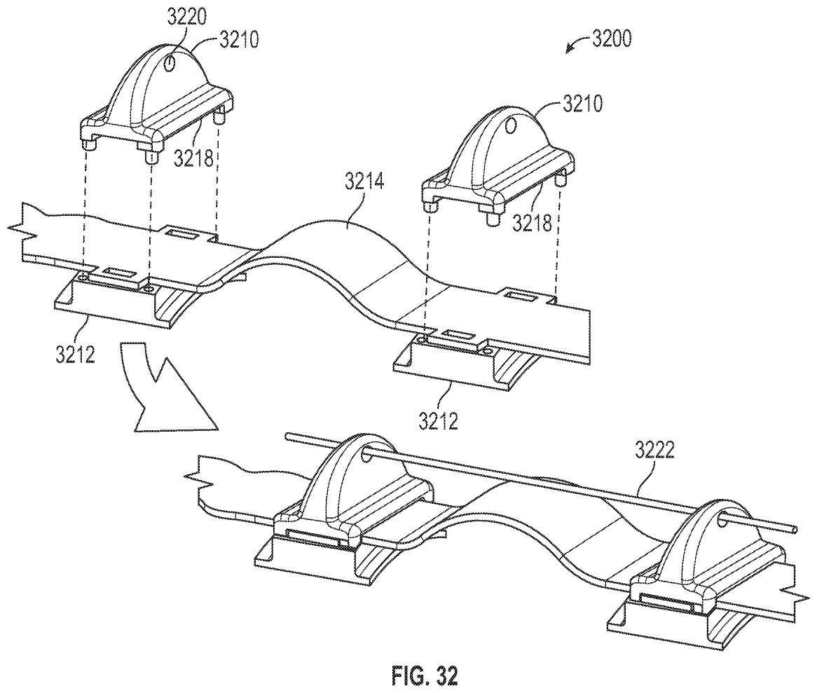

Tendon guides 3022 are secured to inner glove 3010, such as by glue 3030 or rivets. Tendon guides 3022 are described below with reference to FIG. 32.

Tendons 3024 are secured to thimble 3014 and define a load path between the fingertip of finger 3002 and a manipulation actuator, such as manipulation actuators 1972.

In the example provided, tendons 3024 are located on the dorsum of the user's hand and apply forces to the user's finger during grasping motions involving finger flexion while allowing unhindered finger extension. In the example provided, tendons 3024 are 65 lb fishing line. In some embodiments, tendons 3024 are ribbon shaped with a ratio of width to thickness of at least 10.

Finger motion resisted by the manipulation actuator results in reaction forces that are distributed via the load path to the user's finger. In the example provided, the reaction forces terminate at the distal phalange of the finger. In some embodiments, the reaction forces are distributed approximately evenly across the palmar surface of the phalange by silicone panel 3020.

Distributing the net force on the user's fingertip produced by the action of the manipulation actuator promotes approximation of the physical point forces resulting from a particular object interaction. For example, pressing on a simulated pin and a simulated flat surface in a virtual environment might produce identical net forces on the user's fingertip, as rendered by the action of the manipulation actuator. These interactions, however, would produce very different point forces on the skin of the fingertip as rendered by the action of tactile actuators.

Outer glove 3026 may be an outer glove as described below with reference to FIGS. 40-46.

### Tendon Guide Assembly

Referring now to FIG. 32, and with continued reference to FIGS. 1-31, a tendon guide assembly 3200 is illustrated in an exploded view. Tendon guide assembly 3200 includes tendon guide tops 3210, tendon guide bottoms 3212, and FPC 3214 for panel and position sensor.

Tendon guide tops 3210 define an FPC cavity 3218 and a guide aperture 3220 through which tendon 3222 passes. Tendon guide tops 3210 secure to tendon guide bottoms 3212 with, for example, screws or snap features.

Tendon guide bottoms 3212 are glued or riveted to an inner glove of a glove assembly. Tendon guide bottoms 3212 receive FPC 3214 and cooperate with FPC cavity 3218 of tendon guide tops 3210 to restrict movement of FPC 3214.

### Wrist Assembly

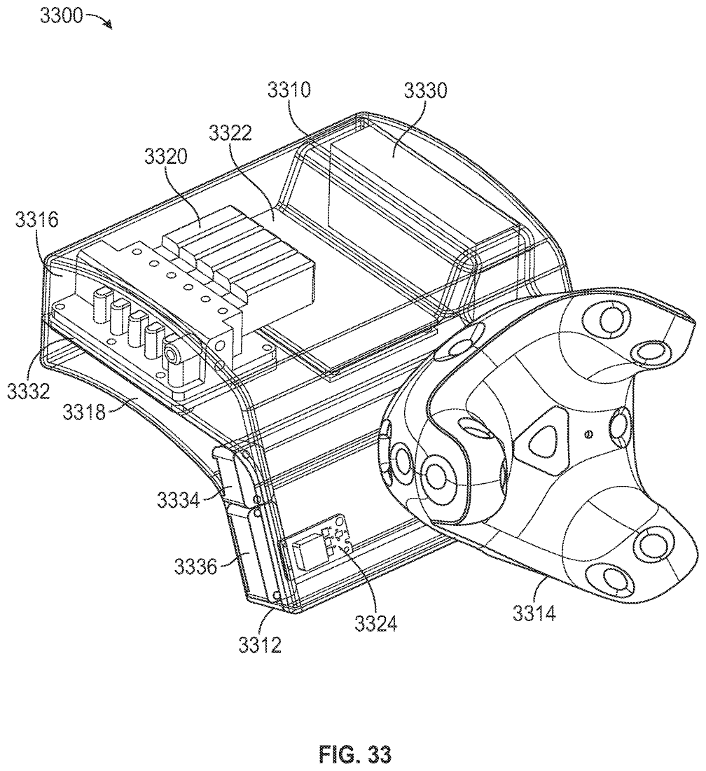

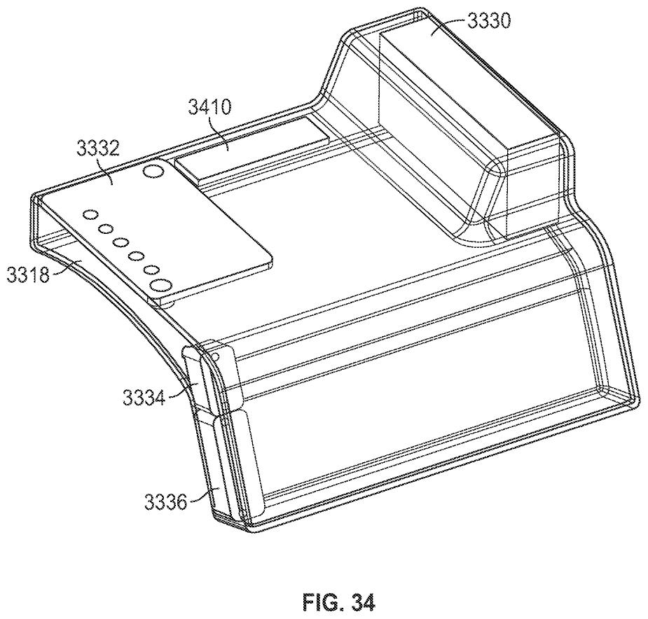

Referring now to FIGS. 33-34, and with continued reference to FIGS. 1-32, a wrist assembly 3300 is illustrated in perspective views. In the example provided, wrist assembly 3300 is mounted to a glove assembly at the back of the user's wrist.

Wrist assembly 3300 includes a durable wrist portion 3310, a replaceable wrist portion 3312, a tracker 3314, an enclosure top 3316, and an enclosure bottom 3318.

Durable wrist portion 3310 is an example of durable subassembly 1910 that attaches to umbilical 1922. Replaceable wrist portion 3312 is an example of replaceable subassembly 1912 connected to the soft goods of the glove assembly. Tracker 3314 is an example of tracker 1926.

Enclosure top 3316 is secured to enclosure bottom 3318 with snaps or screws for user disassembly when replaceable wrist portion 3312 has worn out and must be replaced. For example, the soft goods may rip or become frayed and need replacing after extended use.

Durable wrist portion 3310 includes miniature pneumatic valves and top manifold 3320, position sensor PCBA 3322, and wrist position sensor 3324. Replaceable wrist portion 3312 includes a multi-channel pneumatic connector 3330, a valve bottom manifold 3332, a palm needleless connector 3334, and a thumb needleless connector 3336, a wiring harness 3410, and tubes for panels in Opisthenar (not shown).

Miniature pneumatic valves and top manifold 3320 may be examples of miniature pneumatic valves 1942 and top manifold 1948. Position sensor PCBA 3322 may be an example of position sensor PCBA 1946. Wrist position sensor 3324 may be an example of wrist position sensor 1944.

Multi-channel pneumatic connector 3330 may be an example of multi-channel pneumatic connector 2100. Valve bottom manifold 3332 may be an example of bottom manifold 1960. Palm needleless connector 3334 and a thumb needleless connector 3336 may use face sealing features as shown in FIG. 22. Wiring harness 3410 may be an example of position sensor wire harness 1962.

### Opisthenar Assembly

Referring now to FIG. 35, and with continued reference to FIGS. 1-34, an opisthenar assembly 3500 is illustrated in a perspective view in accordance with the teachings of the present disclosure. Opisthenar assembly 3500 is an example of opisthenar assembly 1712.

Opisthenar assembly 3500 includes an enclosure top 3510, an enclosure bottom 3512, a magnetic emitter 3514, and five manipulation actuators 3520. In the example provided, enclosure top 3510 and enclosure bottom 3512 are injection molded and form a housing with dimensions of about 87 mm wide, 36 mm tall, 66.6 mm long, and a 21 mm ledge height tall. Accordingly, opisthenar assembly 3500 is well sized to be mounted to the glove assembly at the back of the user's hand. Enclosure top 3510 defines finger tendon apertures 3522 and a thumb tendon aperture 3524.

Manipulation actuators 3520 selectively provide force feedback to tendons 3530. Tendons 3530 each pass through one of the four finger tendon apertures 3522 or thumb tendon aperture 3524, route through tendon guides, and connect to thimbles on a respective finger assembly, as discussed above.

In the example provided, manipulation actuators 3520 snap into the housing with snap-fit features. For example, five manipulation actuators 3520 may cooperate with enclosure top 3510 or enclosure bottom 3512 to form an undercut tab and snap feature.

### Manipulation Actuator

Referring now to FIG. 36, and with continued reference to FIGS. 1-35, a manipulation actuator 3520 is illustrated in an exploded view. Manipulation actuator 3520 is a component of a force feedback exoskeleton that produces a net force on a body segment of a user, such as a finger.

Manipulation actuator 3520 includes a cover 3610, a bladder 3612, a brake pad 3614, a wave spring 3616, a retaining ring 3618, a spool 3620, a power spring 3622, and a housing 3624.

Cover 3610 defines clip receiving portions 3630 and housing 3624 defines clip portions 3632. Covers 3610 assembles to housing 3624 such that clip portions 3632 snap into portions 3630 and secure cover 3610 to housing 3624.

Housing 3624 further defines a cavity 3634 and a rotation restriction slot 3636. Cavity 3634 receives power spring 3622, spool 3620, retaining ring 3618, wave spring 3616, brake pad 3614, and bladder 3612.

Bladder 3612 inflates and deflates according to properties of air supplied to bladder 3612 by a drive system, such as drive system 110. Inflation of bladder 3612 causes brake pad 3614 to contact spool 3620 to apply forces opposing rotation of spool 3620 and extension of tendon 3530, as described below.

Brake pad 3614 defines protrusions 3640 and a Hirth joint mating surface 3642. Protrusions 3640 extend radially out from brake pad 3614 and have shapes and locations corresponding to the shape of rotation restriction slot 3636. Accordingly, protrusions 3640 are disposed within rotation restriction slot 3636 when cover 3610 is installed on housing 3624 and brake pad 3614 is disposed in cavity 3634.

Wave spring 3616 biases brake pad 3614 away from spool 3620 such that brake pad 3614 does not restrict rotation of spool 3620 or extension of tendons 3530 when bladder 3612 is not inflated.

Retaining ring 3618 restrains movement, but not elongation and compression, of wave spring 3616. Retaining ring 3618 in turn is restrained from moving by spool 3620.

Spool 3620 accommodates tendons 3530 and defines a Hirth joint mating surface 3650 opposing Hirth joint mating surface 3642 of brake pad 3614. Hirth joing mating surface 3650 and Hirth joint mating surface 3642 each define substantially triangular teeth. The term “substantially triangular” means that the teeth may have curved faces or other variations that maintain the function of the Hirth joint.

Power spring 3622 increasingly biases spool 3620 to a retracted state in response to rotation of spool 3620 and extension of tendon 3530.

To actuate manipulation actuator 3520, high pressure air inflates bladder 3612. Bladder 3612 presses against both cover 3610 and brake pad 3614. Because cover 3610 is secured to housing 3624, cover 3610 does not substantially move and is able to provide counter pressure as bladder 3612 biases brake pad 3614 toward spool 3620. When actuation forces from bladder 3612 on brake pad 3614 are sufficient to overcome the biasing forces of wave spring 3616, brake pad 3614 translates toward spool 3620.

When Hirth joint mating surface 3642 of brake pad 3614 contacts Hirth joint mating surface 3650 of spool 3620, friction and interference between teeth in the Hirth joint restrict movement of spool 3620. The friction forces include a component that opposes separation of brake pad 3614 and spool 3620. The friction forces further include a component that opposes rotation forces between brake pad 3614 and spool 3620, but this component is less than the forces for flat surfaces at any given actuation force to an extent determined by the angle of teeth in the Hirth joint. The forces required to overcome interference between teeth of the Hirth joint, however, are significantly different from flat surface brake pad assemblies. For example, in the absence of deformation of materials or separation of brake pad 3614 from spool 3620 (such as by movement of bladder 3612), there will be no movement of spool 3620 relative to brake pad 3614. Accordingly, materials and actuation pressures are selected based on these considerations for an intentionally slip-permitting Hirth joint. In the example provided, the Hirth joint is actuated in an on/off control scheme and has a predetermined brake design holding force that may be overcome for limiting component breakage in the human-computer interface system. For example, the brake design holding force may be a threshold force on tendon 3530. Above the threshold force, bladder 3612 may compress enough to permit a yielding translation and relative rotation between brake pad 3614 and spool 3620 even when manipulation actuator 3520 is actuated.

### Glove PCB

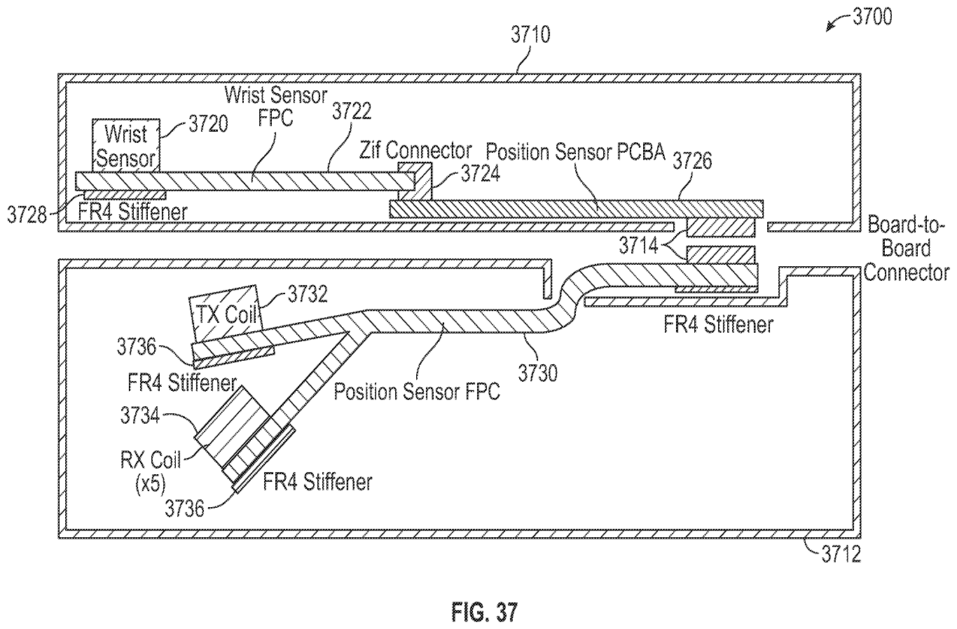

Referring now to FIG. 37, glove electronics 3700 are illustrated in a simplified block diagram. Glove electronics 3700 are implemented as a combination of flexible printed circuits (FPCs) and a rigid circuit board. The shape and angles of the FPCs are based on average hand sizes, and the shapes and angles may be reliably fabricated with an automated FPC process.

In the example provided, glove electronics 3700 includes durable wrist electronics 3710, replaceable electronics 3712, and board connector 3714.

Durable wrist electronics 3710 include a wrist sensor 3720, a wrist sensor FPC 3722, an FPC to PCBA connector 3724, a position sensor PCBA 3726, and a stiffener 3728. Wrist sensor 3720 is an example of wrist position sensor 3324. Wrist sensor FPC 3722 is a flexible printed circuit connecting wrist sensor 3720 to position sensor PCBA 3726 through PCBA connector 3724. FPC to PCBA connector 3724 may be any suitable electronic connector, such as a ZIF connector. Position sensor PCBA 3726 is an example of position sensor PCBA 1946. Stiffener 3728 restricts flexing of the FCB near wrist sensor 3720.

Replaceable electronics 3712 include a position sensor harness FPC 3730, a magnetic emitter 3732, position sensors 3734, and stiffeners 3736.

Position sensor harness FPC 3730 is a flexible printed circuit that connects magnetic emitter 3732 and position sensors 3734 to position sensor PCBA 3726 through board connector 3714. Magnetic emitter 3732 may be an example of magnetic emitter 230. Position sensors 3734 may be examples of position sensors 232. Stiffeners 3736 restrict flexing of the FCB near magnetic emitter 3732 and position sensors 3734.

In the example provided, position sensor PCBA 3726 mounts to a durable assembly with screws or heat staking, wrist Sensor FPC 3722 mounts to the durable assembly with screws or heat staking, and position sensor harness FPC 3730 mounts to a replaceable wrist assembly with board connector 3714 exposed to interface with the durable assembly.

### Integration of Hard and Soft Goods

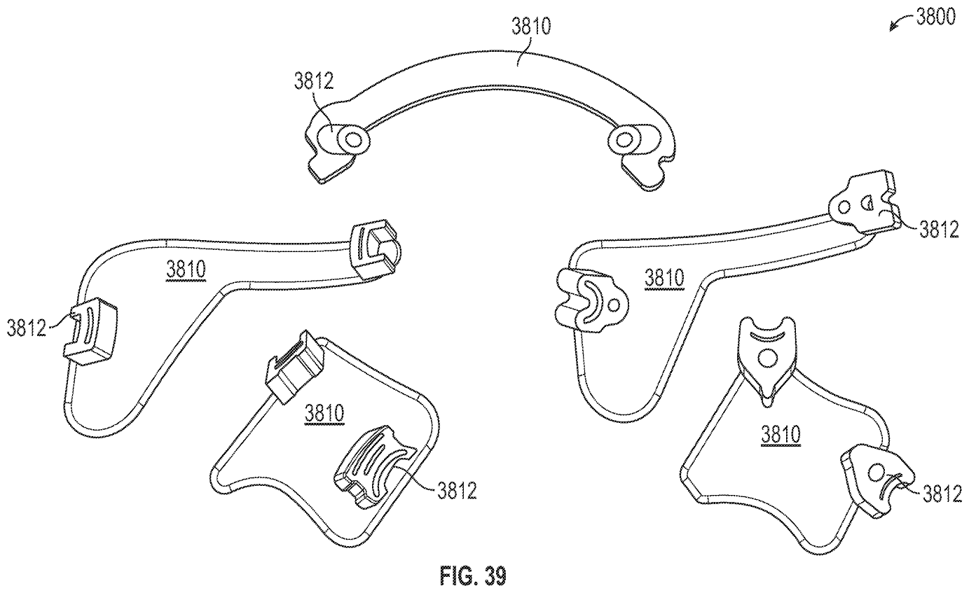

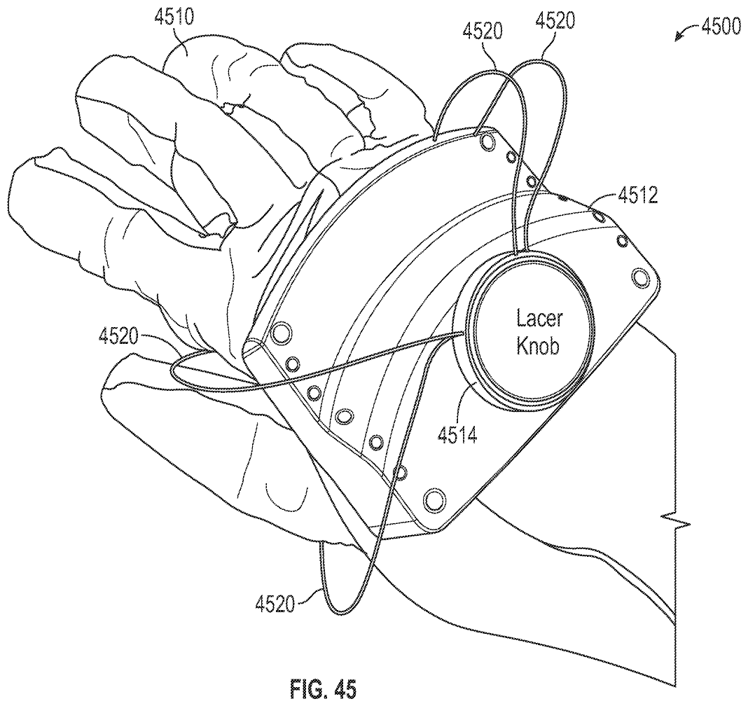

Referring now to FIGS. 38-39, and with continued reference to FIGS. 1-37, a palm assembly 3800 is illustrated in perspective views. Palm assembly 3800 includes substrates 3810, rivets 3812, and lacer guides 3814. Rivets 3812 are secured to substrates 3810, and lacer guides 3814 receive and guide lacers, which are discussed below with reference to FIG. 45. Substrates 3810 are counter pressure features formed into a thin and semi-flexible piece of plastic that is connected to the soft goods by rivets 3812.

Referring now to FIG. 40, and with continued reference to FIGS. 1-39, an outer glove 4000 is illustrated in a perspective view according to the teachings of the present disclosure. Outer glove 4000 includes a cuff portion 4010, a palm portion 4012, and reinforcements 4020. Reinforcements 4020 may be flexible plastic, leather, or other materials. Reinforcements 4020 define rivet holes 4022 through which rivets pass through on assembly of the glove.

Referring now to FIG. 41, and with continued reference to FIGS. 1-40, a palm tactile panel layout 4100 is illustrated in a front view in accordance with some embodiments. Tactile panel layout 4100 includes a first tactile panel 4110, a second tactile panel 4112, and a third tactile panel 4112. With reference back to FIG. 40, it can be seen that the locations of the tactile panels correspond to the locations of reinforcements 4020. Accordingly, counterpressure to the tactile panels may be spread across reinforcements 4020 and into outer glove 4000.

Individual tactors within tactile panels may be grouped into zones, as indicated by zones 4120 of first tactile panel 4110. In the example provided, each tactor within a zone is actuated by the same pneumatic channel as the other tactors in the same zone.

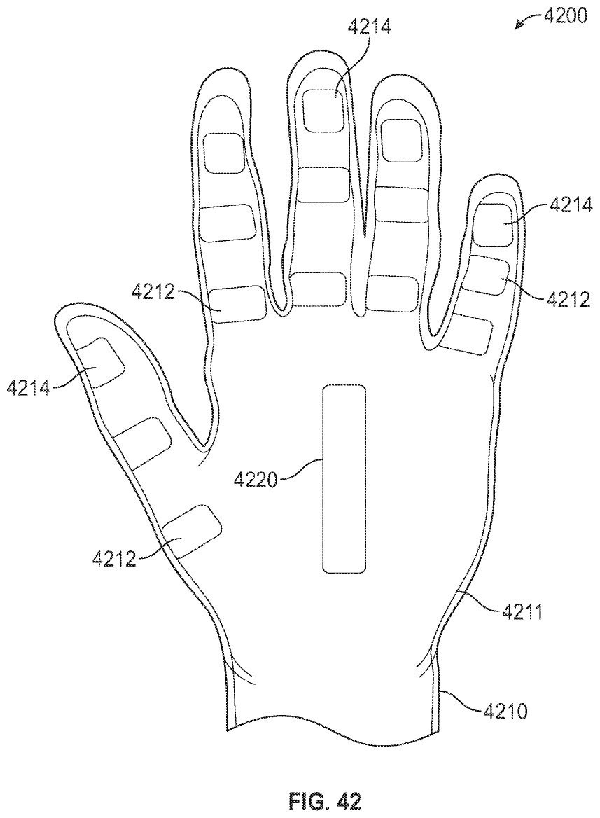

Referring now to FIG. 42, and with continued reference to FIGS. 1-41, a glove assembly 4200 is illustrated in a simplified diagram in accordance with the teachings of the present disclosure. Glove assembly 4200 includes an outer glove 4210, tendon guides 4212, and pucks 4214. Outer glove 4210 may be an example of outer glove 3026. Tendon guides 4212 may be an example of tendon guides 3022. Pucks 4214 may be examples of puck 3012.

Outer glove 4210 defines a service slot 4220 through which inner glove 4211 may be inserted or removed.

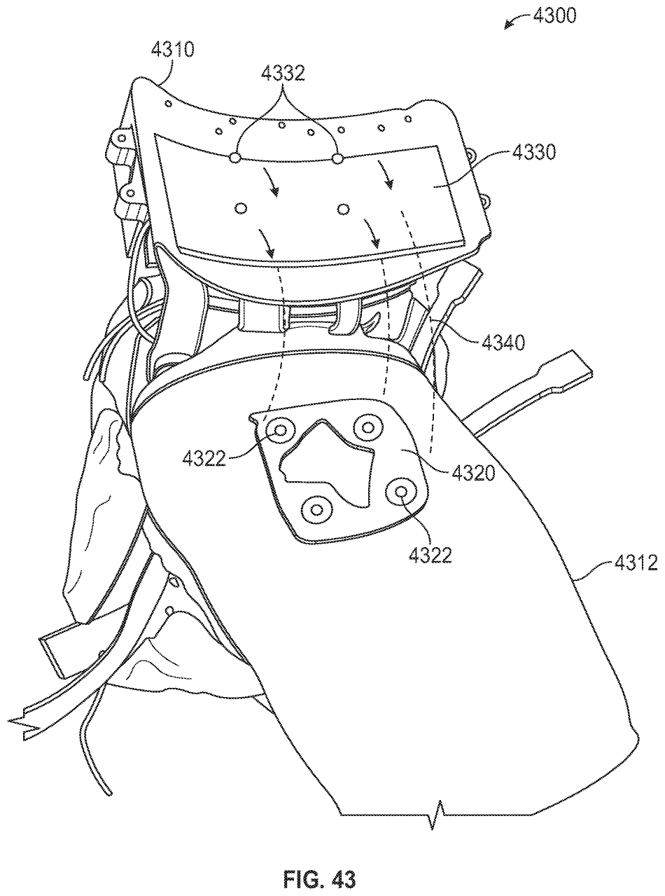

Referring now to FIG. 43, and with continued reference to FIGS. 1-42, an opisthenar and glove assembly 4300 is illustrated in a perspective view in accordance with some embodiments. Opisthenar and glove assembly 4300 includes opisthenar assembly 4310 and outer glove 4312. Outer glove 4312 includes a mounting component 4320 that defines locating features 4322 and has a hook and loop surface. Opisthenar assembly 4310 includes a hook and loop portion 4330 and locating features 4332. In the example provided, mounting component 4320 is sewn into outer glove 4312.

During assembly of opisthenar assembly 4310 to outer glove 4312, features 4322 align with features 4332 to ensure a correct alignment of opisthenar assembly 4310 on outer glove 4312. It should be appreciated that similar alignment features may be used on other complementary connectors having complementary connector components without departing from the scope of the present disclosure. The hook and loop surface of mounting component 4320 couples with hook and loop portion 4330 to secure opisthenar assembly 4310 to outer glove 4312. Opisthenar assembly 4310 installs onto outer glove 4312 as indicated by alignment indicator lines 4340.

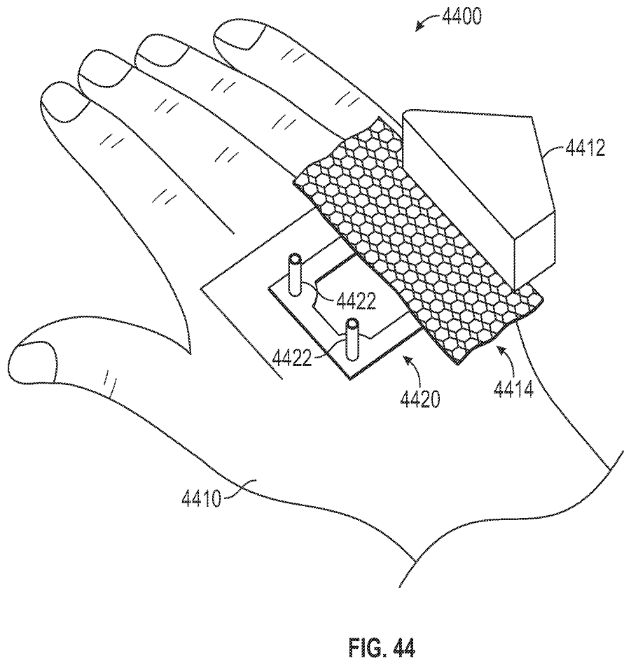

Referring now to FIG. 44, and with continued reference to FIGS. 1-43, an opisthenar and glove assembly 4400 is illustrated in a perspective view in accordance with the teachings of the present disclosure. Opisthenar and glove assembly 4400 includes a glove 4410, an opisthenar assembly 4412, and a mesh layer 4414.

Glove 4410 includes a rigid plate 4420 sewn into mesh layer 4414 and the fabric of glove 4410. Rigid plate 4420 defines locating bosses 4422 configured to interact with and align opisthenar assembly 4412. During assembly of opisthenar and glove assembly 4400, opisthenar assembly 4412 may be secured to rigid plate 4420 with screws interacting with threaded bores formed in plate 4420.

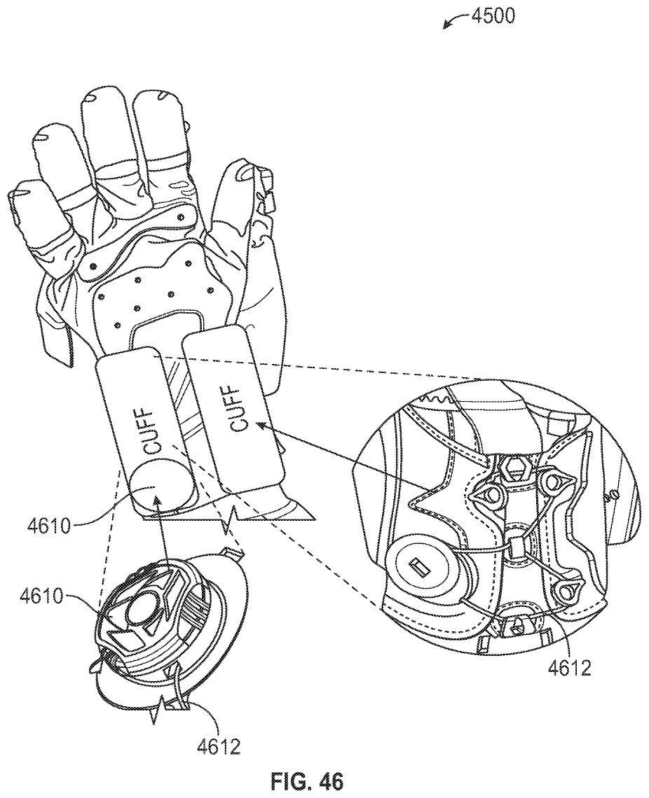

Referring now to FIGS. 45-46, and with continued reference to FIGS. 1-44, a glove assembly 4500 is illustrated in a perspective view according to the teachings of the present disclosure. Glove assembly 4500 includes a glove 4510, an opisthenar assembly 4512, and a lacer knob 4514. Glove 4510 includes a cuff portion 4516. Lacer knob 4514 includes lacers 4520. Lacer knob 4514 is configured to tighten lacers 4520, such as by turning lacer knob 4514. Tightening lacers 4520 tightens the opisthenar assembly by way of lacer guides 3814.

Glove assembly 4500 further includes a cuff lacer 4610. Cuff lacer 4610 is disposed on cuff portion 4516 and includes lacer 4612. Cuff lacer 4610 tightens lacer 4612 to tighten cuff portion 4516, as can be seen in FIG. 46. The use of two separate lacers improves the grounding of forces in the glove assembly to the body of the user.

### Pneumatic Routing

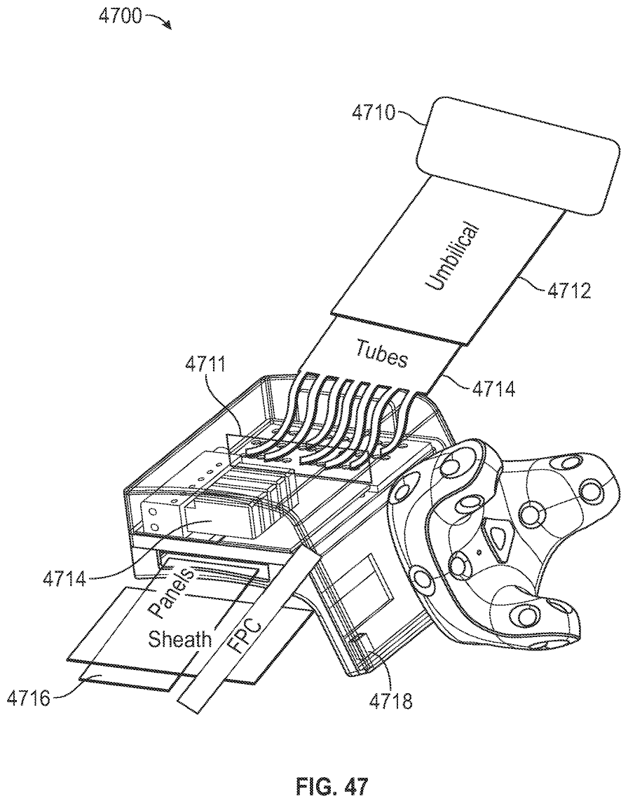

Referring now to FIG. 47, a pneumatic routing assembly 4700 is illustrated in a simplified block diagram. Pneumatic routing assembly 4700 illustrates the route taken by supply and exhaust air between a drive system and tactile panels in a glove assembly.

Pneumatic routing assembly 4700 includes an umbilical 4712 and a wrist assembly 4714. Umbilical 4712 may be an example of umbilical assembly 1716. In the example, provided, umbilical assembly 1716 includes a first multi-channel pneumatic connector 4710 and a second multi-channel pneumatic connector 4710. Wrist assembly 4714 is an example of wrist assembly 3300 and includes a top manifold and multi-channel pneumatic connector, such as multi-channel pneumatic connector 2100.

Referring now to FIG. 48, a tubing harness 4800 is illustrated in a perspective view. Tubing harness 4800 illustrates how the supply and exhaust air is routed between a drive system manifold 712 and pneumatic routing assembly 4700.

Tubing harness 4800 includes a multi-channel pneumatic connector 4810, tubing 4812, tube management features 4814, manifold connectors 4816, and manifold connector gaskets 4818. Manifold connectors 4816 interface with valve core manifolds of a drive system, such as at manifold connectors 1026 of manifold assemblies 712. In the example provided, multi-channel pneumatic connector 4810 is an example of first multi-channel pneumatic connector 4710. In the example provided, tubing 4812 includes 60 lengths of Tygon® brand tubing, manifold connectors 4816 include six connectors, and manifold connector gaskets 4818 include six gaskets.

### Deployment

While only a few embodiments of the disclosure have been shown and described, it will be obvious to those skilled in the art that many changes and modifications may be made thereunto without departing from the spirit and scope of the disclosure as described in the following claims. All patent applications and patents, both foreign and domestic, and all other publications referenced herein are incorporated herein in their entireties to the full extent permitted by law.

The methods and systems described herein may be deployed in part or in whole through machines that execute computer software, program codes, and/or instructions on a processor. The disclosure may be implemented as a method on the machine(s), as a system or apparatus as part of or in relation to the machine(s), or as a computer program product embodied in a computer readable medium executing on one or more of the machines. In embodiments, the processor may be part of a server, cloud server, client, network infrastructure, mobile computing platform, stationary computing platform, or other computing platforms. A processor may be any kind of computational or processing device capable of executing program instructions, codes, binary instructions and the like, including a central processing unit (CPU), a general processing unit (GPU), a logic board, a chip (e.g., a graphics chip, a video processing chip, a data compression chip, or the like), a chipset, a controller, a system-on-chip (e.g., an RF system on chip, an AI system on chip, a video processing system on chip, or others), an integrated circuit, an application specific integrated circuit (ASIC), a field programmable gate array (FPGA), an approximate computing processor, a quantum computing processor, a parallel computing processor, a neural network processor, or other type of processor. The processor may be or may include a signal processor, digital processor, data processor, embedded processor, microprocessor or any variant such as a co-processor (math co-processor, graphic co-processor, communication co-processor, video co-processor, AI co-processor, and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor, or any machine utilizing one, may include non-transitory memory that stores methods, codes, instructions and programs as described herein and elsewhere. The processor may access a non-transitory storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache, network-attached storage, server-based storage, and the like.

A processor may include one or more cores that may enhance speed and performance of a multiprocessor. In embodiments, the process may be a dual core processor, quad core processors, other chip-level multiprocessor and the like that combine two or more independent cores (sometimes called a die).

The methods and systems described herein may be deployed in part or in whole through machines that execute computer software on various devices including a server, client, firewall, gateway, hub, router, switch, infrastructure-as-a-service, platform-as-a-service, or other such computer and/or networking hardware or system. The software may be associated with a server that may include a file server, print server, domain server, internet server, intranet server, cloud server, infrastructure-as-a-service server, platform-as-a-service server, web server, and other variants such as secondary server, host server, distributed server, failover server, backup server, server farm, and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for the execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (SaaS), platform as a service (PaaS), and/or infrastructure as a service (IaaS).

The methods, program codes, and instructions described herein and elsewhere may be implemented on a cellular network with multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, 4G, 5G, LTE, EVDO, mesh, or other network types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic book readers, music players and the like. These devices may include, apart from other components, a storage medium such as flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, network-attached storage, network storage, NVME-accessible storage, PCIE connected storage, distributed storage, and the like.

The methods and systems described herein may transform physical and/or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable code using a processor capable of executing program instructions stored thereon as a monolithic software structure, as standalone software modules, or as modules that employ external routines, code, services, and so forth, or any combination of these, and all such implementations may be within the scope of the disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices, artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described in the disclosure may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described in the disclosure, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the devices described in the disclosure, as well as heterogeneous combinations of processors, processor architectures, or combinations of different hardware and software, or any other machine capable of executing program instructions. Computer software may employ virtualization, virtual machines, containers, dock facilities, portainers, and other capabilities.

Thus, in one aspect, methods described in the disclosure and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described in the disclosure may include any of the hardware and/or software described in the disclosure. All such permutations and combinations are intended to fall within the scope of the disclosure.

While the disclosure has been disclosed in connection with the preferred embodiments shown and described in detail, various modifications and improvements thereon will become readily apparent to those skilled in the art. Accordingly, the spirit and scope of the disclosure is not to be limited by the foregoing examples, but is to be understood in the broadest sense allowable by law.

1. A compressor assembly, comprising:
a housing defining a first end and a second end opposing the first end;
a first compressor disposed at the first end of the housing and positioned in a first orientation;
a second compressor disposed at the second end of the housing and positioned in a second orientation that opposes vibration of the first compressor in the first orientation; and
an outlet portion for providing compressed air from the compressor assembly.

2. The compressor assembly of claim 1, wherein the housing includes a main body, a top cover, and a bottom cover.

3. The compressor assembly of claim 2, wherein the main body defines a pneumatic circuit with a plurality of integral pneumatic conduits.

4. The compressor assembly of claim 3, further comprising a plurality of valves each in pneumatic communication with at least one of the plurality of integral pneumatic conduits.

5. The compressor assembly of claim 4, wherein the main body defines a first aperture and a second aperture in each of the plurality of integral pneumatic conduits.

6. The compressor assembly of claim 5, wherein each of the plurality of valves is in direct pneumatic communication with at least one of the first aperture and the second aperture of at least one of the plurality of integral pneumatic conduits.

7. The compressor assembly of claim 4, wherein the plurality of integral pneumatic conduits defines at least one sound absorbing portion configured to muffle sound traveling through the pneumatic circuit.

8. The compressor assembly of claim 7, further comprising a sound absorbing material disposed in the at least one sound absorbing portion.

9. The compressor assembly of claim 4, wherein the main body defines a first desiccant conduit and a second desiccant conduit, the first desiccant conduit defining a first aperture and a second aperture, the second desiccant conduit defining a third aperture and a fourth aperture, wherein the first desiccant conduit defines a first desiccant portion between the first aperture and the second aperture of the first desiccant conduit, and wherein the second desiccant conduit defines a second desiccant portion between the third aperture and the fourth aperture of the second desiccant conduit.

10. The compressor assembly of claim 1, further comprising:
a first desiccant portion;
a second desiccant portion; and
a plurality of valves configured to direct a first air flow and a second air flow, the plurality of valves having:
a first configuration that directs the first air flow from the first compressor and the second compressor through the first desiccant portion to the outlet portion, wherein the first configuration directs the second air flow from the first air flow through the second desiccant portion for desiccant drying in the second desiccant portion; and
a second configuration that directs the first air flow from the first compressor and the second compressor through the second desiccant portion to the outlet portion, wherein the second configuration directs the second airflow from the first air flow through the first desiccant portion for desiccant drying in the first desiccant portion.

11. The compressor assembly of claim 10, wherein the first compressor and the second compressor create a vacuum portion, and wherein the plurality of valves are configured to direct the second air flow to the vacuum portion in the first configuration and in the second configuration.

12. The compressor assembly of claim 10, wherein the first configuration directs the second air flow beginning at the first air flow after the first air flow has passed through one of the first desiccant portion and the second desiccant portion.

13. The compressor assembly of claim 10, further comprising at least one of a third desiccant portion and a fourth desiccant portion, and wherein the plurality of valves are further configured to direct the second air flow through one of the at least one of the third desiccant portion and the fourth desiccant portion.

14. The compressor assembly of claim 13, wherein the first configuration and the second configuration direct the second air flow beginning at the first air flow before the first air flow passes through either of the first desiccant portion or the second desiccant portion.

15. The compressor assembly of claim 13, wherein the first compressor and the second compressor are configured to cooperatively energize for out of phase vibration cancelation.

16-63. (canceled)
